(19) United States
(12) Patent Application Publication
(10) Pub. No.: US 2024/0430273 A1
(43) Pub. Date: Dec. 26, 2024

(54) MACHINE LEARNING TECHNIQUES FOR IDENTIFYING ANOMALOUS VULNERABILITY DATA

(71) Applicant: Rapid7, Inc., Boston, MA (US)

(72) Inventors: Stuart Millar, Bangor (GB); Gudlaugur Finnbogason, Belfast (GB)

(21) Appl. No.: 18/338,259

(22) Filed: Jun. 20, 2023

(51) Int. Cl. H04L 9/40

(52) U.S. Cl. CPC H04L 63/1416

(57) ABSTRACT

Some embodiments provide a vulnerability data processing system that uses machine learning (ML) to identify anomalous vulnerability data among vulnerability data acquired for configuring vulnerability detection of a computer network security system configured to monitor a computing environment. The system obtains vulnerability data that comprises values of a vulnerability parameter. The system generates datapoints representing values of the vulnerability parameter included in the obtained vulnerability data. The system clusters the datapoints to obtain vulnerability parameter clusters. The system identifies anomalous vulnerability data using the vulnerability parameter clusters.

### BACKGROUND

Computing security is important to provide in various types of computing environments including private cloud computing environments (e.g., cloud infrastructure operated for one organization), public cloud computing environments (e.g., cloud infrastructure made available for use by others, for example, over the Internet or any other network, e.g., via subscription, to multiple organizations), a hybrid cloud computing environment (a combination of publicly-accessible and private infrastructure), an on-premise computing infrastructure, a single computing device, and/or any other type of computing environment.

Cloud computing enables the delivery of software, data, and other computing resources to remote devices and computing locations. A cloud computing environment may contain many physical and virtual assets which communicate via various computer network protocols. These assets may host various data and software applications. Providing cloud computing security is important to protect the data, software applications, virtual assets, physical assets, and other infrastructure of a cloud computing environment.

### SUMMARY

Some embodiments provide a method of using machine learning (ML) to identify anomalous vulnerability data among vulnerability data acquired for configuring vulnerability detection of a computer network security system configured to monitor a computing environment. The method comprises using at least one computer hardware processor to perform: obtaining vulnerability data comprising a plurality of values of a vulnerability parameter, wherein the vulnerability parameter can be used to configure detection of at least one vulnerability in the computing environment by the computer network security system; generating a plurality of datapoints representing the plurality of values of the vulnerability parameter; clustering the plurality of datapoints to obtain a plurality of vulnerability parameter clusters; identifying at least one outlier datapoint using the plurality of vulnerability parameter clusters, the at least one outlier datapoint indicating at least one anomalous value of the vulnerability parameter; identifying anomalous vulnerability data among the obtained vulnerability data using the at least one outlier datapoint indicating the at least one anomalous value of the vulnerability parameter; and outputting an indication of the anomalous vulnerability data.

In some embodiments, the computing environment is configured to use a plurality of virtual machines (VMs) to execute a plurality of software applications. In some embodiments, the vulnerability parameter can be used to configure detection of the at least one vulnerability in at least one of the plurality of software applications.

In some embodiments, generating the plurality of datapoints representing the plurality of values of the vulnerability parameter comprises: deduplicating the plurality of values of the vulnerability parameter to obtain a set of deduplicated vulnerability parameter values; and generating the plurality of datapoints using the set of deduplicated vulnerability parameter values. In some embodiments, generating the plurality of datapoints using the set of deduplicated vulnerability parameter values comprises: applying a mask to the set of deduplicated vulnerability parameter values to obtain a plurality of masked vulnerability parameter values; deduplicating the plurality of masked vulnerability parameter values to obtain a set of deduplicated masked vulnerability parameter values; and generating the plurality of datapoints using the set of deduplicated masked vulnerability parameter values. In some embodiments, generating the plurality of datapoints using the set of deduplicated masked vulnerability parameter values comprises: encoding each of the set of deduplicated masked vulnerability parameter values as a respective fixed-length vector of numeric values to obtain a plurality of fixed-length vectors as the plurality of datapoints. In some embodiments, encoding each of the set of deduplicated masked vulnerability parameter values as a respective fixed-length vector of numeric values comprises providing each of the set of deduplicated masked vulnerability parameter values as input to a trained encoder model to obtain the respective fixed-length vector of numeric values.

In some embodiments, obtaining the plurality of values of the vulnerability parameter comprises executing a vulnerability data acquisition agent that extracts the plurality of values of the vulnerability parameter from a vulnerability data source. In some embodiments, obtaining the plurality of values of the vulnerability parameter comprises obtaining at least one of the plurality of values of the vulnerability parameter through a graphical user interface (GUI).

In some embodiments, clustering the plurality of datapoints to obtain the vulnerability parameter clusters comprises clustering the plurality of datapoints using a density-based clustering algorithm. In some embodiments, the density-based clustering algorithm is a density-based spatial clustering of applications with noise (DBSCAN) algorithm.

In some embodiments, the method further comprises: obtaining an additional value of the vulnerability parameter; generating an additional datapoint representing the additional value of the vulnerability parameter; determining a measure of similarity between the additional datapoint and the plurality of datapoints; and determining cluster membership of the additional datapoint based on the measure of similarity between the additional datapoint and the plurality of datapoints. In some embodiments, the method further comprises: determining, based on the cluster membership of the additional datapoint, that the additional datapoint is an outlier that is outside of the plurality of vulnerability parameter clusters; and outputting an indication that the additional value of the vulnerability parameter is an anomalous value.

In some embodiments, the method further comprises: filtering out the at least one anomalous value of the vulnerability parameter from the plurality of values of the vulnerability parameter to obtain a filtered set of values of the vulnerability parameter; and configuring the computer network security system to monitor at least one software application for the at least one vulnerability using the filtered set of values of the vulnerability parameter. In some embodiments, configuring the computer network security system to monitor the at least one software application for the at least one vulnerability associated using the filtered set of values of the vulnerability parameter comprises configuring the computer network security system to: determine whether the at least one software application is configured in accordance with at least one of the filtered set of values; and when it is determined that the at least one software application is configured in accordance with the at least one filtered value, update the at least one software application and/or apply a control to the at least one software application to compensate for the at least one vulnerability.

In some embodiments, the method further comprises: after clustering the plurality of datapoints to obtain the plurality of vulnerability parameter clusters: obtaining additional vulnerability data comprising additional values of the vulnerability parameter; generating an updated plurality of datapoints representing the updated plurality of values of the vulnerability parameter; applying the clustering algorithm to the updated plurality of datapoints to obtain an updated plurality of vulnerability clusters; and using the updated plurality of vulnerability clusters to identify datasets including anomalous data.

In some embodiments, the method further comprises: executing a plurality of vulnerability data acquisition agents to obtain vulnerability parameter values; for each agent of the plurality of vulnerability data acquisition agents: generating a set of datapoints representing vulnerability parameter values obtained from execution of the agent; clustering the set of datapoints to obtain a respective plurality of vulnerability parameter clusters; and using the respective plurality of vulnerability parameter clusters to identify datasets obtained from subsequent execution of the agent that include anomalous data.

In some embodiments, generating the set of datapoints representing the vulnerability parameter values obtained from execution of the agent comprises: generating a set of masked vulnerability parameter values using the vulnerability parameter values obtained from execution of the agent; providing the set of masked vulnerability parameter values as input to the trained encoder model associated with the agent to obtain the set of datapoints; and using a trained encoder model associated with the agent to generate the datapoints. In some embodiments, using the trained encoder model associated with the agent to generate the datapoints comprises: deduplicating the vulnerability parameter values obtained from execution of the agent to obtain a set of deduplicated vulnerability parameter values; applying a mask to the set of deduplicated vulnerability parameter values; deduplicating the set of deduplicated vulnerability parameter values to obtain a set of deduplicated masked vulnerability parameter values; and providing the set of deduplicated masked vulnerability parameter values as input to the trained encoder model associated with the agent to obtain the datapoints.

In some embodiments, the method further comprises: executing a first vulnerability data acquisition agent to obtain first vulnerability data including a first vulnerability parameter value; executing a second vulnerability data acquisition agent to obtain second vulnerability data including a second vulnerability parameter value; generating a first datapoint representing the first vulnerability parameter value using a first trained encoder model associated with the first vulnerability data acquisition agent; and generating a second datapoint representing the second vulnerability parameter value using a second trained encoder model associated with the second vulnerability data acquisition agent.

In some embodiments, the plurality of datapoints comprises a plurality of fixed-length vectors of numeric values. In some embodiments, the plurality of values of the vulnerability parameter are strings. In some embodiments, the vulnerability parameter is a version number of a software application program.

In some embodiments, the plurality of values of the vulnerability parameter is a plurality of strings and the plurality of datapoints is a plurality of fixed-length numeric vectors representing respective ones of the plurality of strings; and generating the plurality of datapoints representing the plurality of values of the vulnerability parameter comprises generating the plurality of fixed-length numeric vectors.

Some embodiments provide a vulnerability data processing system. The system comprises: at least one computer hardware processor; and at least one non-transitory computer-readable storage medium storing instructions that, when executed by the at least one computer hardware processor, causes the at least one computer hardware processor to perform a method of using machine learning (ML) to identify anomalous vulnerability data among vulnerability data acquired for configuring vulnerability detection of a computer network security system configured to monitor a computing environment. The method comprises: obtaining vulnerability data comprising a plurality of values of a vulnerability parameter, wherein the vulnerability parameter can be used to configure detection of at least one vulnerability in the computing environment by the computer network security system; generating a plurality of datapoints representing the plurality of values of the vulnerability parameter; clustering the plurality of datapoints to obtain a plurality of vulnerability parameter clusters; identifying at least one outlier datapoint using the plurality of vulnerability parameter clusters, the at least one outlier datapoint indicating at least one anomalous value of the vulnerability parameter; identifying anomalous vulnerability data among the obtained vulnerability data using the at least one outlier datapoint indicating the at least one anomalous value of the vulnerability parameter; and outputting an indication of the anomalous vulnerability data.

Some embodiments provide a non-transitory computer-readable storage medium storing instructions that, when executed by at least one computer hardware processor, cause the at least one computer hardware processor to perform a method of using machine learning (ML) to identify anomalous vulnerability data among vulnerability data acquired for configuring vulnerability detection of a computer network security system configured to monitor a computing environment. The method comprises: obtaining vulnerability data comprising a plurality of values of a vulnerability parameter, wherein the vulnerability parameter can be used to configure detection of at least one vulnerability in the computing environment by the computer network security system; generating a plurality of datapoints representing the plurality of values of the vulnerability parameter; clustering the plurality of datapoints to obtain a plurality of vulnerability parameter clusters; identifying at least one outlier datapoint using the plurality of vulnerability parameter clusters, the at least one outlier datapoint indicating at least one anomalous value of the vulnerability parameter; identifying anomalous vulnerability data among the obtained vulnerability data using the at least one outlier datapoint indicating the at least one anomalous value of the vulnerability parameter; and outputting an indication of the anomalous vulnerability data.

The foregoing summary is non-limiting.

### BRIEF DESCRIPTION OF DRAWINGS

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1A shows an illustrative cloud computing environment in which a computer network security system and a vulnerability data processing system may operate, according to some embodiments of the technology described herein.

FIG. 1B shows the interaction among modules of the vulnerability data processing system of FIG. 1A to identify anomalous vulnerability data, according to some embodiments of the technology described herein.

FIG. 2 is a diagram illustrating the generation of datapoints for identifying anomalous vulnerability data, according to some embodiments of the technology described herein.

FIG. 3A shows the application of a clustering algorithm to a set of datapoints representing vulnerability parameter values, according to some embodiments of the technology described herein.

FIG. 3B shows vulnerability parameter clusters obtained from the application of the clustering algorithm of FIG. 3A, according to some embodiments of the technology described herein.

FIG. 3C illustrates the use of outlier datapoints for identifying anomalous vulnerability data, according to some embodiments of the technology described herein.

FIG. 4A illustrates the generation of a new datapoint representing a vulnerability parameter value from an acquired dataset, according to some embodiments of the technology described herein.

FIG. 4B illustrates the use of the new datapoint of FIG. 4A for identifying anomalous vulnerability data, according to some embodiments of the technology described herein.

FIG. 4C illustrates the generation of another datapoint representing a vulnerability parameter value from an acquired dataset, according to some embodiments of the technology described herein.

FIG. 4D illustrates the use of datapoint of FIG. 4C to determine that vulnerability dataset is non-anomalous, according to some embodiments of the technology described herein.

FIG. 5A illustrates the generation of a clustering model for each of multiple vulnerability data acquisition agents, according to some embodiments of the technology described herein.

FIG. 5B illustrates the use of the sets of vulnerability parameter clusters of FIG. 5A for identifying anomalous vulnerability data obtained by the vulnerability data acquisition agents, according to some embodiments of the technology described herein. FIG. 9A is an example dataset including a vulnerability parameter value, according to some embodiments of the technology described herein.

FIG. 6 is a flowchart of an example process of identifying anomalous vulnerability data among vulnerability data, according to some embodiments of the technology described herein.

FIG. 7 is a flowchart of an example process of determining whether acquired vulnerability data is anomalous, according to some embodiments of the technology described herein.

FIG. 8A is an example dataset including a vulnerability parameter value, according to some embodiments of the technology described herein.

FIG. 8B is an example of generating datapoints using vulnerability parameter values extracted from datasets, according to some embodiments of the technology described herein.

FIG. 8C is an example set of vulnerability parameter clusters obtained from applying a clustering algorithm to the datapoints generated in FIG. 8B, according to some embodiments of the technology described herein.

FIG. 9 shows a block diagram of an exemplary computing device, in accordance with some embodiments of the technology described herein.

### DETAILED DESCRIPTION

Detection of vulnerabilities in software applications executed in a computing environment is an important aspect of computer network security for the computing environment. For example, a computer network security system may detect vulnerabilities in software applications executed by virtual machines (VMs) in a cloud computing environment. Various types of computer network security systems are used to provide security including cloud access security brokers (CASBs), cloud workload protection platforms (CWPPs), web application firewalls (WAFs), cloud-native security information and event management solutions (SIEMs), intrusion detection systems (IDSs), and/or other types of systems.

A computer network security system has to frequently update its vulnerability detection to be up to date with changes in a computing environment (e.g., a cloud computing environment or an on-premise computing infrastructure) that the computer network security system protects. For example, updates in software application programs executed by VMs and/or containers in a cloud computing environment may need corresponding updates in vulnerability detection performed by the computer network security system. As another example, the computer network security system may need to be updated to be able to detect new types of vulnerabilities in software applications executed by VMs and/or containers in a cloud computing environment. Vulnerability data may include values of various vulnerability parameters (e.g., software application version identifiers, application feature identifiers, software update identifiers, and/or other vulnerability parameters). A computer network security system is typically updated by acquiring vulnerability data from vulnerability data sources and using the vulnerability data to update the computer network security system's vulnerability detection. For example, the computer network security system may be updated with vulnerability data that is periodically acquired from a website associated with a software application and/or a common vulnerabilities and exposures (CVE) database that stores CVE records describing vulnerabilities.

The inventors have recognized that acquired vulnerability data may include anomalous data which may be unfit for use in configuring vulnerability detection of a computer network security system. For example, the data may include improper vulnerability parameter values. Anomalous vulnerability parameter values may degrade vulnerability detection of a computer network security system (e.g., by failing to detect vulnerabilities or falsely identifying vulnerabilities). Given the large volume of vulnerability data (e.g., up to 100,000 files) that may be obtained for a single application executable in a computing environment, it is challenging to identify anomalous vulnerability data. Moreover, anomalous vulnerability data needs to be identified in new vulnerability data that is continuously being acquired over time to keep vulnerability detection up to date. Conventional systems are overwhelmed with the amount of vulnerability data that needs to be checked for anomalous content.

Accordingly, the inventors have developed machine learning-based techniques for efficiently and reliably detecting anomalous vulnerability data. The techniques improve the performance of vulnerability detection of a computer network security system by reducing the amount of anomalous vulnerability data that is used to configure a computer network security system. The techniques automatically identify anomalous data in previously acquired vulnerability data as well as in vulnerability data that is acquired over time (e.g., as part of updating a computer network security system).

In particular, the inventors have developed techniques for identifying anomalous data in vulnerability data acquired for configuring vulnerability detection performed by a computer network security system in a computing environment. The techniques use machine learning to identify vulnerability parameter values that are anomalous. The anomalous data may be triaged such that it is not used to configure vulnerability detection of a computer network security system at least until it is further investigated and approved by an appropriate user (e.g., security specialist or systems administrator). The computer network security system may be automatically configured using vulnerability data with anomalous data filtered out. In this way, the technology developed by the inventors mitigates the deleterious effects of anomalous vulnerability data on vulnerability detection of the computer network security system. The technology further allows for continuous automated filtering of anomalous vulnerability data.

Though the technology is broadly applicable to various types of computer network security systems (examples of which are provided herein), in the context of a computing environment (e.g., a cloud computing environment), the technology may be used to improve the detection of vulnerabilities in software applications executed by computing devices in the computing environment (e.g., using virtual machines (VMs), containers, and/or other virtualized computation resources in a cloud computing environment). For example, the techniques may be used to identify anomalous version numbers of the software applications that are executed by VMs in a cloud computing environment. The computer network security system may be configured to perform detection without searching for the anomalous software application version numbers. The techniques may further reduce processes performed to compensate for improperly detected vulnerabilities by eliminating improper detection performed based on anomalous vulnerability data. For example, the techniques may reduce the installation of updates (e.g., patches) on devices and/or configuration of software application programs on the devices performed due to improper detection of vulnerabilities using anomalous data.

Accordingly, some embodiments provide a vulnerability data processing system that uses machine learning (ML) to identify anomalous vulnerability data among vulnerability data acquired for configuring vulnerability detection of a computer network security system configured to monitor a computing environment (e.g., a cloud computing environment). The vulnerability data processing system may be configured to obtain vulnerability data that comprises values of a vulnerability parameter (e.g., software version identifier). The vulnerability parameter may be used to configure detection of one or more vulnerabilities in the computing environment (e.g., when the value of the vulnerability parameter is valid). The vulnerability data processing system may be configured to generate datapoints representing values of the vulnerability parameter included in the obtained vulnerability data. The vulnerability data processing system may be configured to cluster the datapoints to obtain vulnerability parameter clusters. The vulnerability data processing system may be configured to identify one or more outlier datapoints using the vulnerability parameter clusters. The identified outlier datapoint(s) indicate one or more anomalous vulnerability parameter values. The vulnerability data processing system may be configured to use the outlier datapoint(s) to identify anomalous vulnerability data among the obtained vulnerability data (e.g., by labeling dataset(s) including an anomalous vulnerability parameter value as anomalous). The vulnerability data processing system may be configured to output an indication of the identified anomalous vulnerability data (e.g., through a GUI of a user device).

Accordingly, some embodiments provide for a method of using machine learning (ML) to identify anomalous vulnerability data among vulnerability data acquired for configuring vulnerability detection of a computer network security system configured to monitor a computing environment (e.g., a cloud computing environment in which VMs and/or containers are used to execute software applications), the method comprising: (A) obtaining vulnerability data comprising a plurality of values of a vulnerability parameter (e.g., software application version number), wherein the vulnerability parameter can be used to configure detection of at least one vulnerability (e.g., in a software application) in the computing environment by the computer network security system; (B) generating a plurality of datapoints (e.g., fixed-length numeric vectors) representing the plurality of values (e.g., strings) of the vulnerability parameter; (C) clustering the plurality of datapoints to obtain a plurality of vulnerability parameter clusters (e.g., using a density-based clustering algorithm, for example, DBSCAN); (D) identifying at least one outlier datapoint using the plurality of vulnerability parameter clusters, the at least one outlier datapoint indicating at least one anomalous value of the vulnerability parameter; (E) identifying anomalous vulnerability data among the obtained vulnerability data using the at least one outlier datapoint indicating the at least one anomalous value of the vulnerability parameter; and (F) outputting an indication of the anomalous vulnerability data (e.g., by labeling a file storing the anomalous vulnerability data as anomalous).

In some embodiments, generating the plurality of datapoints representing the plurality of values of the vulnerability parameter comprises: (A) deduplicating the plurality of values of the vulnerability parameter to obtain a set of deduplicated vulnerability parameter values (e.g., a unique set of vulnerability parameter values); and (B) generating the plurality of datapoints using the set of deduplicated vulnerability parameter values. In some embodiments generating the plurality of datapoints using the set of deduplicated vulnerability parameter values comprises: (A) applying a mask to the set of deduplicated vulnerability parameter values to obtain a plurality of masked vulnerability parameter values; (B) deduplicating the plurality of masked vulnerability parameter values to obtain a set of deduplicated masked vulnerability parameter values (e.g., a set of unique masked vulnerability parameter values); and (B) generating the plurality of datapoints using the set of deduplicated masked vulnerability parameter values. In some embodiments, generating the plurality of datapoints using the set of deduplicated masked vulnerability parameter values comprises: encoding each of the set of deduplicated masked vulnerability parameter values as a respective fixed-length vector of numeric values to obtain a plurality of fixed-length vectors as the plurality of datapoints. In some embodiments, encoding each of the set of deduplicated masked vulnerability parameter values as a respective fixed-length vector of numeric values comprises providing each of the set of deduplicated masked vulnerability parameter values as input to a trained encoder model to obtain the respective fixed-length vector of numeric values.

In some embodiments, obtaining the plurality of values of the vulnerability parameter comprises executing a vulnerability data acquisition agent that extracts the plurality of values of the vulnerability parameter from a vulnerability data source (e.g., a website or a CVE database). In some embodiments, obtaining the plurality of values of the vulnerability parameter comprises obtaining at least one of the plurality of values of the vulnerability parameter through a graphical user interface (GUI).

In some embodiments, the method further comprises: (A) obtaining an additional value of the vulnerability parameter (e.g., in a newly acquired file); (B) generating an additional datapoint representing the additional value of the vulnerability parameter; (C) determining a measure of similarity (e.g., a distance) between the additional datapoint and the plurality of datapoints; and (D) determining cluster membership of the additional datapoint based on the measure of similarity between the additional datapoint and the plurality of datapoints. In some embodiments, the method further comprises: (A) determining, based on the cluster membership of the additional datapoint, that the additional datapoint is an outlier that is outside of the plurality of vulnerability parameter clusters; and (B) outputting an indication that the additional value of the vulnerability parameter is an anomalous value.

In some embodiments, the method further comprises: (A) filtering out the at least one anomalous value of the vulnerability parameter from the plurality of values of the vulnerability parameter to obtain a filtered set of values of the vulnerability parameter; and (B) configuring the computer network security system to monitor at least one software application for the at least one vulnerability using the filtered set of values of the vulnerability parameter. In some embodiments, configuring the computer network security system to monitor the at least one software application for the at least one vulnerability associated using the filtered set of values of the vulnerability parameter comprises configuring the computer network security system to: (A) determine whether the at least one software application is configured in accordance with at least one of the filtered set of values; and (B) when it is determined that the at least one software application is configured in accordance with the at least one filtered value, update the at least one software application and/or apply a control to the at least one software application to compensate for the at least one vulnerability.

In some embodiments, the method further comprises: after clustering the plurality of datapoints to obtain the plurality of vulnerability parameter clusters: (A) obtaining additional vulnerability data comprising additional values of the vulnerability parameter; (B) generating an updated plurality of datapoints representing the updated plurality of values of the vulnerability parameter; (C) applying the clustering algorithm to the updated plurality of datapoints to obtain an updated plurality of vulnerability clusters; and (D) using the updated plurality of vulnerability clusters to identify datasets including anomalous data.

In some embodiments, the method further comprises: executing a plurality of vulnerability data acquisition agents to obtain vulnerability parameter values; and for each agent of the plurality of vulnerability data acquisition agents: (A) generating a set of datapoints representing vulnerability parameter values obtained from execution of the agent; (B) clustering the set of datapoints to obtain a respective plurality of vulnerability parameter clusters; and (C) using the respective plurality of vulnerability parameter clusters to identify datasets obtained from subsequent execution of the agent that include anomalous data. In some embodiments, generating the set of datapoints representing the vulnerability parameter values obtained from execution of the agent comprises: using a trained encoder model associated with the agent to generate the datapoints. In some embodiments, using the trained encoder model associated with the agent to generate the datapoints comprises: (A) deduplicating the vulnerability parameter values obtained from execution of the agent to obtain a set of deduplicated vulnerability parameter values; (B) applying a mask to the set of deduplicated vulnerability parameter values; (C) deduplicating the set of deduplicated vulnerability parameter values to obtain a set of deduplicated masked vulnerability parameter values; and (C) providing the set of deduplicated masked vulnerability parameter values as input to the trained encoder model associated with the agent to obtain the datapoints.

In some embodiments, the method further comprises: (A) executing a first vulnerability data acquisition agent to obtain first vulnerability data including a first vulnerability parameter value; (B) executing a second vulnerability data acquisition agent to obtain second vulnerability data including a second vulnerability parameter value; (C) generating a first datapoint representing the first vulnerability parameter value using a first trained encoder model (e.g., an encoder of a first trained variational autoencoder (VAE)) associated with the first vulnerability data acquisition agent; and (D) generating a second datapoint representing the second vulnerability parameter value using a second trained encoder model (e.g., an encoder of a second trained VAE) associated with the second vulnerability data acquisition agent.

Example embodiments may be described herein in the context of a cloud computing environment. However, some embodiments may be used in other types of computing environments such as an on-premise computing infrastructure and/or a single computing device.

For example, some embodiments provide a vulnerability data processing system that uses machine learning (ML) to identify anomalous vulnerability data among vulnerability data acquired for configuring vulnerability detection of a computer network security system configured to monitor an on-premise computing infrastructure. The vulnerability data processing system may be configured to obtain vulnerability data that comprises values of a vulnerability parameter (e.g., software version identifier). The vulnerability parameter may be used to configure detection of one or more vulnerabilities in the on-premise computing infrastructure (e.g., when the value of the vulnerability parameter is valid). The vulnerability data processing system may be configured to generate datapoints representing values of the vulnerability parameter included in the obtained vulnerability data. The vulnerability data processing system may be configured to cluster the datapoints to obtain vulnerability parameter clusters. The vulnerability data processing system may be configured to identify one or more outlier datapoints using the vulnerability parameter clusters. The identified outlier datapoint(s) indicate one or more anomalous vulnerability parameter values. The vulnerability data processing system may be configured to use the outlier datapoint(s) to identify anomalous vulnerability data among the obtained vulnerability data (e.g., by labeling dataset(s) including an anomalous vulnerability parameter value as anomalous). The vulnerability data processing system may be configured to output an indication of the identified anomalous vulnerability data (e.g., through a GUI of a user device).

As another example, some embodiments provide a vulnerability data processing system that uses machine learning (ML) to identify anomalous vulnerability data among vulnerability data acquired for configuring vulnerability detection of a computer network security system configured to monitor a computing device. The vulnerability data processing system may be configured to obtain vulnerability data that comprises values of a vulnerability parameter (e.g., software version identifier). The vulnerability parameter may be used to configure detection of one or more vulnerabilities in the computing device (e.g., when the value of the vulnerability parameter is valid). The vulnerability data processing system may be configured to generate datapoints representing values of the vulnerability parameter included in the obtained vulnerability data. The vulnerability data processing system may be configured to cluster the datapoints to obtain vulnerability parameter clusters. The vulnerability data processing system may be configured to identify one or more outlier datapoints using the vulnerability parameter clusters. The identified outlier datapoint(s) indicate one or more anomalous vulnerability parameter values. The vulnerability data processing system may be configured to use the outlier datapoint(s) to identify anomalous vulnerability data among the obtained vulnerability data (e.g., by labeling dataset(s) including an anomalous vulnerability parameter value as anomalous). The vulnerability data processing system may be configured to output an indication of the identified anomalous vulnerability data (e.g., through a GUI of a user device).

Following below are more detailed descriptions of various concepts related to, and embodiments of, the vulnerability data processing systems and methods developed by the inventors. It should be appreciated that various aspects described herein may be implemented in any of numerous ways. Examples of specific implementations are provided herein for illustrative purposes only. In addition, the various aspects described in the embodiments below may be used alone or in any combination and are not limited to the combinations explicitly described herein.

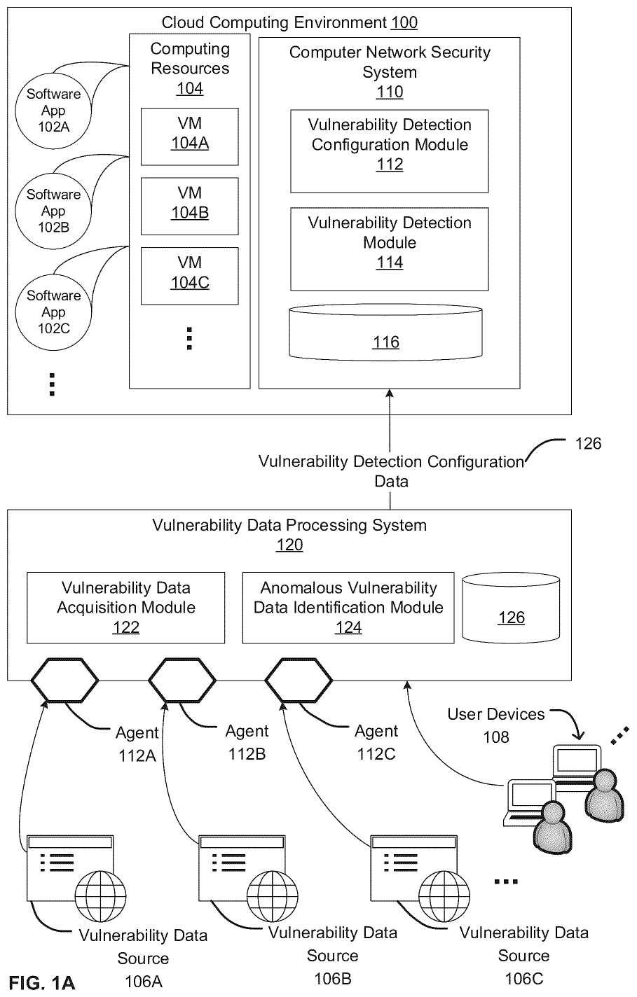

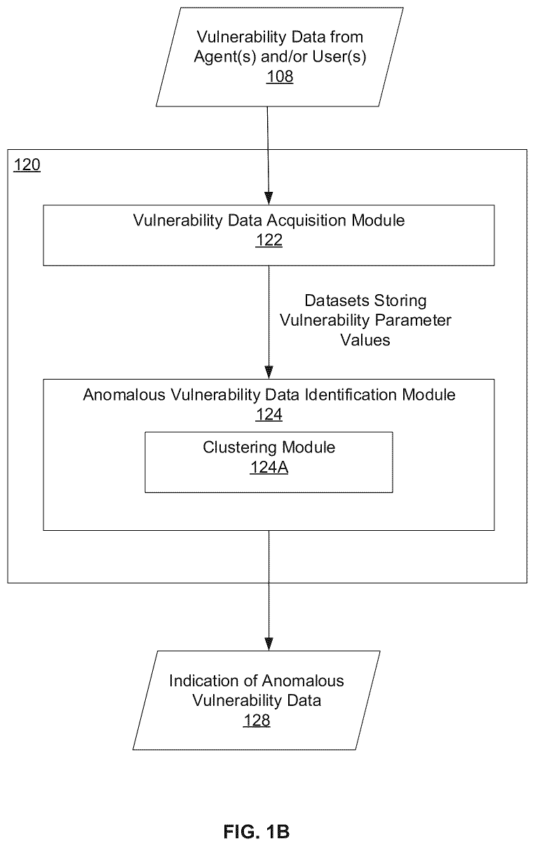

FIG. 1A shows an illustrative cloud computing environment 100 in which a computer network security system 110 and a vulnerability data processing system 120 may operate, according to some embodiments of the technology described herein. As illustrated in the example embodiment of FIG. 1A, the cloud computing environment 100 includes virtual machines computing resources 104 that executes software applications 102A, 102B, 102C. The computer network security system 110 may be configured to monitor the computing resources 104. The computer network security system 110 may be configured to detect vulnerabilities in the software applications 102A, 102B, 102C being executed by the computing resources 104. The vulnerability data processing system 120 may be configured to acquire vulnerability data from various vulnerability data sources 106A, 106B, 106C, and process the data to provide vulnerability detection configuration data 126 to the computer network security system 110 to configure vulnerability detection of the computer network security system 110. The vulnerability data processing system 120 may be configured to process acquired vulnerability data to filter out anomalous data that may potentially degrade vulnerability detection of the computer network security system 110.

As illustrated in FIG. 1A, the software applications 102A, 102B, 102C are executed in a cloud computing environment 100. The computing resources 104 may comprise networks, computing devices (e.g., servers), storage (e.g., databases), and/or other computing resources. Each of the software applications 102A, 102B, 102C, and the computer network security system 110 may be executed using computing resources of the cloud computing environment 100. In some embodiments, the software applications 102A, 102B, 102C and the computer network security system 110 may be executed using cloud computing resources provided by a cloud computing service provider such as GOOGLE CLOUD, AMAZON WEB SERVICES (AWS), MICROSOFT AZURE and/or another cloud computing service provider.

As illustrated in the example embodiment of FIG. 1A, the cloud computing environment 100 includes computing resources 104. The computing resources 104 may be digitally abstracted and made available for the execution of software applications. Computing resources 104 may be instantiated and distributed as needed to execute various software applications. Physical computing hardware of the cloud computing environment 100 may host one or more of the Computing resources 104 to execute one or more software applications.

In the example embodiment of FIG. 1A, the computing resources 104 are abstracted as virtual machines (VMs) 104A, 104B, 104C. The computing resources 104 may include additional VMs not shown in FIG. 1A. In some embodiments, the VMs 104A, 104B, 104C may be instantiated in the cloud computing environment 100 to execute the software applications 102A, 102B, 102C. For example, the VMs 104A, 104B, 104C may be instantiated in response to request(s) from one or more client devices to execute the software applications 102A, 102B, 102C. Each of the VMs 104A, 104B, 104C may be instantiated and executed using computing resources in the cloud computing environment 100. For example, each of the VMs 104A, 104B, 104C may be instantiated on a different respective server. As another example, VMs 104A, 104B may be instantiated on one server while VM 104C may be instantiated on another server. Each of the software applications 102A, 102B, 102C may be executed by one or more of the Computing resources 104. For example, software application 102A may be executed by VM 104A. As another example, software application 102B may be jointly executed by Computing resources 104B, 104C.

Although in the example embodiment of FIG. 1A the computing resources 104 include VMs 104A, 104B, 104C, in some embodiments, the computing resources 104 may include other computing resources instead of or including the VMs 104A, 104B, 104C. For example, the computing resources 104 may include one or more containers. As another example, the computing resources 104 may comprise computing resources of an on-premise computing infrastructure that the computer network security system 110 is configured to protect. As another example, the computing resources 104 may be the computing resources of a single computing device that the computer network security system 110 is configured to protect.

In some embodiments, the computer network security system 110 may be configured to monitor the Computing resources 104. The computer network security system 110 may be configured to monitor the computing resources 104 for vulnerabilities in the software applications 102A, 102B, 102C being executed by the Computing resources 104. In some embodiments, the computer network security system 110 may be configured to detect vulnerabilities in the computing resources 104 that make them susceptible to attacks by an adversary. For example, the computer network security system 110 may be configured to detect a vulnerability that makes a VM susceptible to a denial of service attack on one of the software applications 102A, 102B, 102C. As another example, the computer network security system 110 may be configured to detect a vulnerability that makes a VM executing one of the software applications 102A, 102B, 102C susceptible to isolation. As another example, the computer network security system 110 may be configured to detect a vulnerability that makes a VM susceptible to insecure migration from one set of physical resources to another set of physical resources. As another example, the computer network security system 110 may be configured to detect a vulnerability that makes a VM susceptible to a breach of data on the VM (e.g., that provides unauthorized access to software application data). As another example, the computer network security system 110 may be configured to detect a vulnerability that makes the computing resources 104 susceptible to guest-to-guest attacks in which one VM infects other VMs with malicious software.

In some embodiments, the computer network security system 110 may be implemented using one or more servers in the cloud computing environment 100. For example, the computer network security system 110 may be implemented using one or more servers. The server(s) may be configured to interact with server(s) that host the Computing resources 104.

As shown in the example embodiment of FIG. 1A, the computer network security system 110 includes a vulnerability detection configuration module 112, a vulnerability detection module 114, and a datastore 116.

In some embodiments, the vulnerability detection configuration module 112 may be configured to configure the computer network system's 110 vulnerability detection. The vulnerability detection configuration module 112 may be configured to modify vulnerability detection performed by the computer network security system 110. For example, the vulnerability detection configuration module 112 may modify vulnerability detection by configuring the vulnerability detection module 114. In some embodiments, the vulnerability detection configuration module 112 may configure vulnerability detection by

In some embodiments, the vulnerability detection configuration module 112 may configure vulnerability detection of the computer network security system using vulnerability detection configuration data 126 provided by the vulnerability data processing system 120. In some embodiments, the vulnerability detection configuration data 126 may include values of one or more parameters that may be used by the vulnerability detection configuration module 112 to configure vulnerability detection of the computer network security system 110. For example, the vulnerability detection configuration data 126 may include values of a software version that is used by the computer network security system 110 in detecting vulnerabilities. The software version values may be used by the computer network security system 110 to determine whether a version of a software application (e.g., one of software applications 102A, 102B, 102C) being executed is vulnerable to certain threats. As another example, the vulnerability detection configuration data 126 may include a value of a parameter indicating improper access to data.

In some embodiments, the vulnerability detection configuration module 112 may be configured to use the vulnerability detection configuration data 126 to configure vulnerability detection by configuring the computer network security system 110 to determine whether the software applications 102A, 102B, 102C are susceptible to vulnerabilities indicated by the data 126. The vulnerability detection configuration module 112 may be configured to configure the computer network security system to determine whether a software application is susceptible based on identifying parameter values (e.g., indicated in the vulnerability detection configuration data 126). For example, one vulnerability parameter that may be used in performing vulnerability detection is a software version identifier. The vulnerability detection configuration module 112 may configure the computer network security system 110 to: (1) determine a software version identifier of a software application; and (2) determine that the software application is susceptible to one or more vulnerabilities based on the software version identifier (e.g., by accessing information indicating the vulnerabilities associated with the software version identifier). The vulnerability detection configuration module 112 may further configure the computer network security system 110 to perform a remedial action when a vulnerability is detected. For example, the vulnerability detection configuration module 112 may configure the computer network security system 110 to apply a software update (e.g., a patch) to the software application and/or apply control to the software application to compensate for the detected vulnerability.

In some embodiments, the vulnerability detection module 114 may be configured to monitor the computing resources 104 for vulnerabilities in the cloud computing environment 100. The vulnerability module 114 may be configured to monitor the computing resources 104 by monitoring the software applications 102A, 102B, 102C being executed in the cloud computing environment 104. The vulnerability detection module 114 may be configured to scan the software applications 102A, 102B, 102C to detect vulnerabilities. For example, the vulnerability detection module 114 may be configured to scan a software application by accessing data from one or more computing devices of the computing resources 104 executing the software application (e.g., using one or more of the VMs 104A, 104B, 104C). The vulnerability detection module 114 may analyze the data to detect vulnerabilities in the computing environment 100. For example, the vulnerability detection module 114 may access a software version identifier of a software application being executed in the cloud computing environment 100, and use the software version identifier to determine whether the software application is susceptible to one or more vulnerabilities.

In some embodiments, the vulnerability detection module 114 may be configured to perform remedial action in response to detecting a vulnerability. In some embodiments, the vulnerability detection module 114 may be configured to apply a software update to a software application in response to detecting a vulnerability. For example, the vulnerability detection module 114 may access a software patch (e.g., from a provider of the software application) and install the software patch. In some embodiments, the vulnerability detection module 114 may be configured to apply controls to compensate for a detected vulnerability. For example, the vulnerability detection module 114 may modify the parameters of a software application to protect against a detected vulnerability.

In some embodiments, the datastore 116 may comprise storage hardware (e.g., one or more hard drives). The computer network security system 110 may be configured to store vulnerability detection configuration data 126 in the datastore 116. The computer network security system 110 may be configured to store data obtained from monitoring for vulnerabilities. For example, the computer network security system 110 may generate records storing information about detected vulnerabilities and store the records in the datastore 116. The data may be used to provide insights to users of the cloud computing environment 100 (e.g., by generating visualizations in a graphical user interface (GUI) illustrating detected vulnerabilities).

As illustrated in the example embodiment of FIG. 1A, the vulnerability data processing system 120 provides the vulnerability detection configuration data 126 to the computer network security system 110. The vulnerability data processing system 120 includes a vulnerability data acquisition module 122 and an anomalous vulnerability data identification module 124.

In some embodiments, the vulnerability data acquisition module 122 may be configured to acquire vulnerability data from various vulnerability data sources. As illustrated in the example embodiment of FIG. 1A, the vulnerability data acquisition module 122 may be configured to acquire the vulnerability data using various vulnerability data acquisition agents 112A, 112B, 112C (also referred to herein as “agents”). Each of the agents 112A, 112B, 112C may be configured to access data from a respective vulnerability data source. In the example of FIG. 1A, agent 112A accesses vulnerability data from vulnerability data source 106A, agent 112B accesses vulnerability data from vulnerability data source 106B, and agent 112C accesses vulnerability data from vulnerability data source 106C.

In some embodiments, each of the agents 112A, 112B, 112C may be a software application that, when executed, accesses data from a respective one of the vulnerability data sources 106A, 106B, 106C. For example, each of the agents 112A, 112B, 112C may be a software plug-in that is associated with a particular software application. Each of the agents 112A, 112B, 112C may be dedicated to accessing vulnerability data associated with a particular software application. For example, agent 112A may access vulnerability data associated with software application 102A, agent 112B may access vulnerability data associated with software application 102B, and agent 112C may access vulnerability data associated with software application 102C. To illustrate, the agent 112A may access vulnerability data from a website managed by a provider of the software application 102A. For example, the agent 112A may be configured to periodically access vulnerability data from the website (e.g., through an API). As another example, the agent 112A may access vulnerability data from the website in response to a command (e.g., input through a GUI or a programmatically generated software command). Although the example embodiment of FIG. 1A shows three agents 112A, 112B, 112C, in some embodiments, the vulnerability data processing system 120 may be configurable to include any number of agents needed to acquire vulnerability data. For example, the vulnerability data processing system 120 may include an agent for each of a set of software applications executed in the cloud computing environment 100.

A vulnerability data source may be any suitable source of vulnerability data. For example, a vulnerability data source may be an Internet website from which an agent accesses vulnerability data (e.g., by scraping the website and/or accessing the vulnerability data through an application program interface (API)). As another example, a vulnerability data source may be a data repository (e.g., accessible through the Internet). The data repository may store vulnerability data from a software provider of a software application. As another example, a vulnerability data source may be a CVE database storing CVE records that store information about vulnerabilities.

In some embodiments, vulnerability data may include values of one or more parameters that may potentially be used to configure vulnerability detection of the computer network security system 110. For example, vulnerability data may include values of a software version identifier for a software application. As another example, vulnerability data may include an identifier of an adversarial entity (e.g., a virus name, the IP address of another computing device, and/or information identifying malware). As another example, vulnerability data may include parameter values for identifying a malicious communication (e.g., an unauthorized request to access data).

As illustrated in the example embodiment of FIG. 1A, the vulnerability data acquisition module 122 may be configured to access vulnerability data from user devices 108. The vulnerability data acquisition module 122 may be configured to receive vulnerability data from the user devices 108. For example, the vulnerability data acquisition module 122 may receive vulnerability data through a GUI provided to the user devices 108 (e.g., in an Internet website). As another example, the vulnerability data acquisition module 122 may receive from the client devices 108 vulnerability data through an API.

In some embodiments, the vulnerability data acquisition module 122 may be configured to store vulnerability data (e.g., accessed by the agents 112A, 112B, 112C and/or from the client devices 108). For example, the vulnerability data acquisition module 122 may store the vulnerability data in datastore 126. In some embodiments, the data acquisition module 122 may be configured to generate datasets (e.g., files) storing the vulnerability data. For example, the data acquisition module 122 may generate XML files storing acquired vulnerability data. The files may store information for detecting vulnerabilities, solutions for detected vulnerabilities, and metadata that connects vulnerability detection data with solution data. Each file may have multiple entries indicating values of a parameter that can be used to configure vulnerability detection of the computer network security system 110.

In some embodiments, the anomalous vulnerability data acquisition module 124 may be configured to identify anomalous vulnerability data from among the vulnerability data acquired by the vulnerability data acquisition module 122. The anomalous vulnerability data acquisition module 124 may be configured to filter out the identified anomalous vulnerability data from the vulnerability detection configuration data 126 provided to the computer network security system 110. For example, the anomalous vulnerability data acquisition module 124 may label the identified anomalous data for further investigation by a user.

FIG. 1B shows the interaction among modules 122, 124 of the vulnerability data processing system of FIG. 1A to identify anomalous vulnerability data, according to some embodiments of the technology described herein. As shown in FIG. 1B, the anomalous vulnerability data identification module 124 may be configured to access datasets (e.g., XML files) generated by the vulnerability data acquisition module 122. For example, the anomalous vulnerability data identification module 124 may access the datasets from the datastore 126 of the anomalous vulnerability data processing system 120. The datasets may include values of one or more vulnerability parameters. For example, each of the datasets may include a value of a software version identifier.

As illustrated in FIG. 1B, the anomalous vulnerability data identification module 124 may be configured to process the datasets storing values of a vulnerability parameter. The anomalous vulnerability data identification module 124 may be configured to access the values of the vulnerability parameter from the datasets and generate datapoints representing the vulnerability parameter values. For example, the anomalous vulnerability data identification module 124 may generate numerical vectors representing the vulnerability parameter values. To illustrate, the vulnerability parameter may be a software version identifier. The vulnerability parameter values may be string values. The anomalous vulnerability data identification module 124 may generate datapoints representing the string values of the software version identifier. Example techniques of generating datapoints representing vulnerability parameter values are described herein.

As shown in the example embodiment of FIG. 1B, the anomalous vulnerability data identification module 124 includes a clustering module 124A. The anomalous vulnerability data identification module 124 may be configured to use the clustering module 124A to cluster the datapoints and obtain vulnerability parameter clusters. The clustering module 124A may be configured to apply a clustering algorithm to the set of datapoints. Example techniques of clustering are described herein. The anomalous vulnerability data identification module 124 may be configured to use the vulnerability parameter clusters to identify anomalous vulnerability data. In some embodiments, the anomalous vulnerability data identification module 124 may be configured to identify anomalous vulnerability data using the clusters by: (1) identifying one or more outlier datapoints that do not belong to a cluster; and (2) determining vulnerability parameter value(s) represented by the outlier datapoint(s) to be anomalous.

As shown in the example embodiment of FIG. 1B, the anomalous vulnerability data identification module 124 may be configured to output an indication 128 of the identified anomalous vulnerability data. In some embodiments, the anomalous vulnerability data identification module 124 may be configured to label datasets including the anomalous vulnerability parameter value(s) to be anomalous data. For example, the anomalous vulnerability data identification module 124 may label files including the anomalous vulnerability parameter value(s) to be anomalous. The datasets labeled as anomalous may be triaged for further processing. For example, the datasets labeled as anomalous may be stored in a repository (e.g., in datastore 126) of datasets labeled as anomalous by the anomalous vulnerability data identification module 124. In some embodiments, the anomalous vulnerability data identification module 124 may be configured to output the anomalous vulnerability parameter value(s). For example, the anomalous vulnerability data identification module 124 may be configured to store the anomalous vulnerability parameter value(s) in a file for review and/or use in filtering vulnerability data.

In some embodiments, the anomalous vulnerability data identification module 124 may be configured to process newly acquired vulnerability data using vulnerability parameter clusters (e.g., generated by clustering performed using the clustering module 124A) to determine whether the vulnerability data is anomalous. For example, the anomalous vulnerability data identification module 124 may be configured to use the vulnerability parameter clusters to determine whether the vulnerability data is anomalous by: (1) generating a datapoint representing a vulnerability parameter value included in a newly generated dataset; (2) determine a position of the datapoint in a numerical space of the vulnerability parameter clusters; and (3) determine whether the vulnerability parameter value is anomalous based on the position of the datapoint (e.g., by comparing the position of the datapoint to a set of the nearest datapoints that were clustered). The anomalous vulnerability data identification module 124 may be configured to continuously process acquired vulnerability data using the vulnerability parameter clusters. For example, each newly generated dataset including vulnerability parameter value(s) may be processed using he vulnerability parameter clusters.

In some embodiments, the anomalous vulnerability data identification module 124 may be configured to generate a set of vulnerability parameter clusters for each of the agents 112A, 112B, 112C. The anomalous vulnerability data identification module 124 may be configured to generate a set of vulnerability parameter clusters for a given agent by performing clustering using vulnerability data obtained by the agent. For example, a set of vulnerability parameter clusters may be generated using vulnerability data for a particular software application executed in the cloud computing environment 100. The anomalous vulnerability data identification module 124 may be configured to store the set of clusters for each agent, and process vulnerability data as it is obtained by the agent to determine whether the vulnerability data is anomalous.

The vulnerability data processing system 120 may be configured to use the indication 128 of anomalous vulnerability data to determine vulnerability detection configuration data 126 to be provided to the computer network security system 110. In some embodiments, the vulnerability data processing system 120 may be configured to filter out anomalous vulnerability data. For example, the vulnerability data processing system 120 may filter out files labeled as including an anomalous vulnerability parameter value. As another example, the vulnerability data processing system 120 may remove vulnerability parameter values determined to be anomalous from a set of vulnerability data to be provided to the computer network security system 110.

In some embodiments, the datastore 126 of the vulnerability data processing system 120 may comprise storage hardware (e.g., one or more hard drives). The storage hardware may store vulnerability data obtained by the vulnerability data processing system 120. In some embodiments, the datastore 126 may store information indicating anomalous vulnerability data. For example, the datastore 126 may store metadata for files including a label of whether the files were determined to include anomalous vulnerability data.

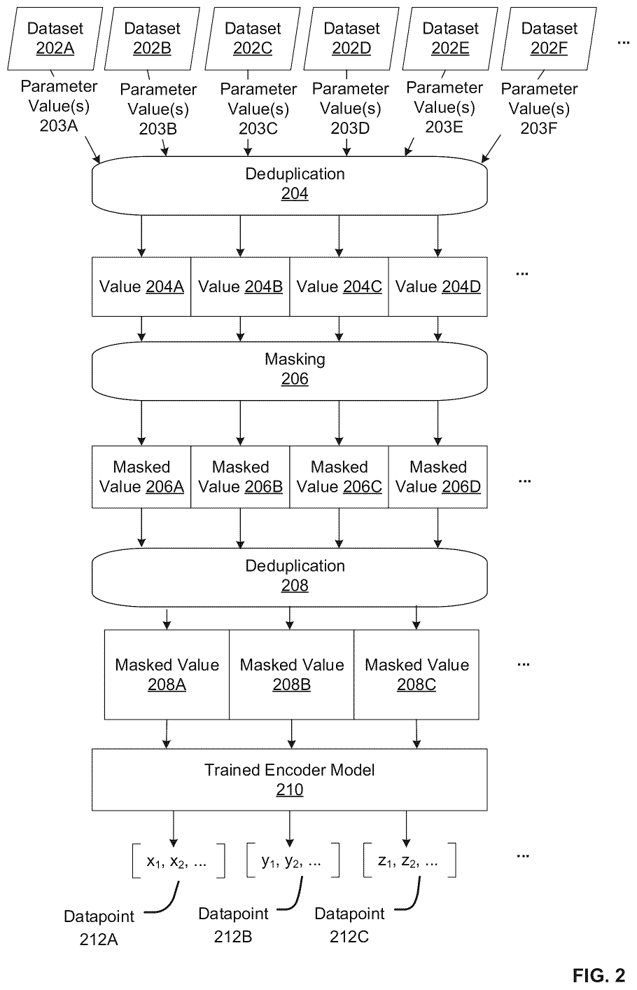

FIG. 2 is a diagram illustrating the generation of datapoints for identifying anomalous vulnerability data, according to some embodiments of the technology described herein. In some embodiments, the technique illustrated in the diagram of FIG. 2 may be used by the vulnerability data processing system 120 to generate a representation of vulnerability data for identifying anomalous vulnerability data. For example, the vulnerability data processing system 120 may use the technique to generate datapoints that can be clustered as part of identifying anomalous vulnerability data. In some embodiments, the technique of FIG. 2 may be used to generate datapoints representing values of a vulnerability parameter (e.g., software version identifier) in acquired vulnerability data.

As shown in FIG. 2, the system extracts vulnerability parameter values from datasets 202A, 202B, 202C, 202D, 202E, 202F. In some embodiments, each of the datasets 202A, 202B, 202C, 202D, 202E, 202F may be obtained by a vulnerability data acquisition agent (e.g., one of agents 112A, 112B, 112C described herein with reference to FIG. 1A). In the example embodiment of FIG. 2, each of the datasets 202A, 202B, 202C, 202D, 202E, 202F may include one or more values of a vulnerability parameter. For example, the datasets 202A, 202B, 202C, 202D, 202E may be XML files including vulnerability parameter value(s) as value(s) of fields in the datasets 202A, 202B, 202C, 202D, 202E. As shown in FIG. 2, the system extracts a set of vulnerability parameter values that includes parameter value(s) 203A from dataset 202A, parameter value(s) 203B from dataset 202B, parameter value(s) 203C from dataset 202C, parameter value(s) 203D from dataset 202D, parameter value(s) 203E from dataset 202E, and parameter value(s) 203F from dataset 202F.

As shown in the example embodiment of FIG. 2 at block 204, the system deduplicates the set of vulnerability parameter values to obtain a set of deduplicated vulnerability parameter values including the values 204A, 204B, 204C, 204D. For example, the values 204A, 204B, 204C may be a set of unique vulnerability parameter values obtained from performing the deduplication. The system may be configured to deduplicate the set of vulnerability parameter values by eliminating duplicate copies of the same vulnerability parameter value in the set of vulnerability parameter values. For example, the set of vulnerability parameter values may include a set of 100,000 or more software version strings. A large portion (e.g., 75% or more) of the software version strings may be duplicated. The system may deduplicate the software version strings to obtain a deduplicated set of software version strings (e.g., a set of unique software version strings). In some embodiments, the system may be configured to deduplicate the set of vulnerability parameter values by: (1) selecting one of the set of vulnerability parameter values; (2) comparing the selected vulnerability parameter value to other values in the set of vulnerability parameter values to identify any duplicates; and (3) updating the set of vulnerability parameter values by removing any identified duplicates of the selected vulnerability parameter value from the set of vulnerability parameter values. The system may be configured to repeat these steps until the system has removed all duplicates from the set of vulnerability parameter values.

As shown in the example embodiment of FIG. 2 at block 206, the system masks the set of deduplicated values 204A, 204B, 204C, 204D. In some embodiments, the system may be configured to mask a vulnerability parameter value by: (1) obtaining a set of data transformation rules; and (2) apply the data transformation rules to the value to obtain a masked value. For example, the system may obtain a set of data transformation rules that include a first rule to transform any numerical character in a vulnerability parameter value to “1” and a second rule to leave any non-numerical character as its original character. The system may apply this example set of data transformation rules to a deduplicated set of software version strings (e.g., a set of unique software version strings) to obtain a masked set of software version strings. In the example embodiment of FIG. 2, the system masks the deduplicated values 204A, 204B, 204C, 204D to obtain masked values 206A, 206B, 206C, 206D.

As shown in the example embodiment of FIG. 2 at block 208, the system deduplicates the masked values 206A, 206B, 206C, 206D to obtain a set of unique masked values 208A, 208B, 208C. Example techniques of deduplicating are described herein with reference to block 204.

As shown in the example embodiment of FIG. 2, the system uses the unique masked values 208A, 208B, 208C as input to a trained encoder model 210 to obtain corresponding datapoints 212A, 212B, 212C. As shown in FIG. 2, each of the datapoints 212A, 212B, 212C may be a numerical vector. In some embodiments, the datapoints 212A, 212B, 212C may be numerical vectors of equal length.

In some embodiments, the trained encoder model 210 may be a machine learning model trained to transform masked vulnerability parameter values into a numerical vector. For example, the machine learning model may be a neural network (e.g., a recurrent neural network (RNN), convolutional neural network (CNN), or another suitable neural network) with parameters (e.g., weights) trained to transform a masked vulnerability parameter value into a numerical vector. In some embodiments, the trained encoder may be an encoder of a trained encoder decoder pair (e.g., of a variational autoencoder (VAE)). In some embodiments, the trained encoder model 210 may be a machine learning model trained on data obtained by a particular vulnerability data acquisition agent. For example, the trained encoder model 210 may be an encoder of a VAE trained using data comprising vulnerability parameter values obtained by the vulnerability data acquisition agent. In this respect, the trained encoder model 210 may be specific to the vulnerability data acquisition agent.

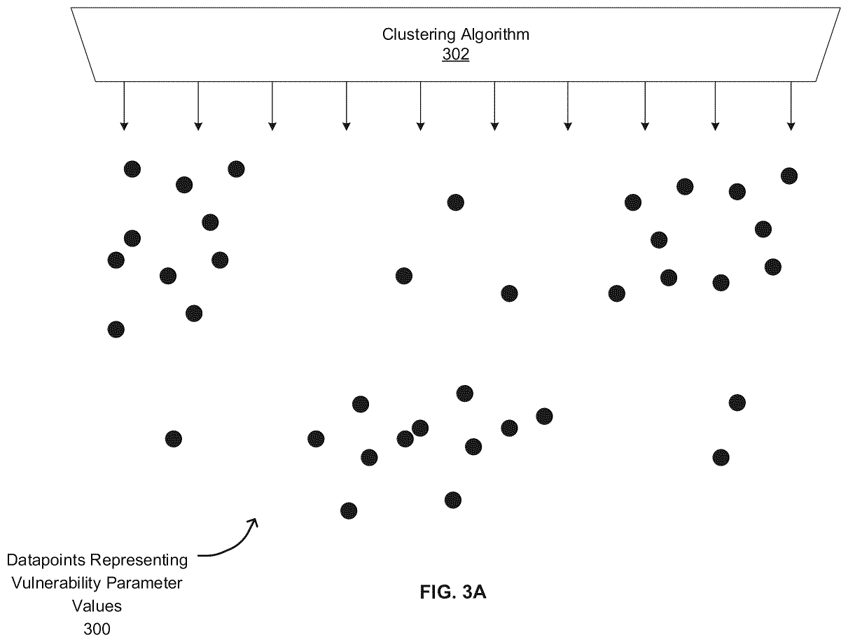

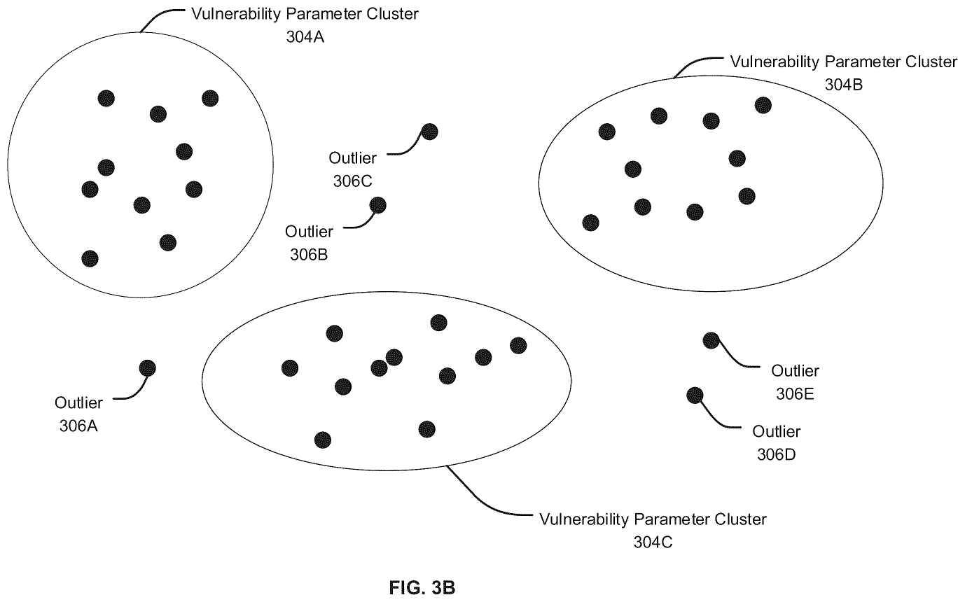

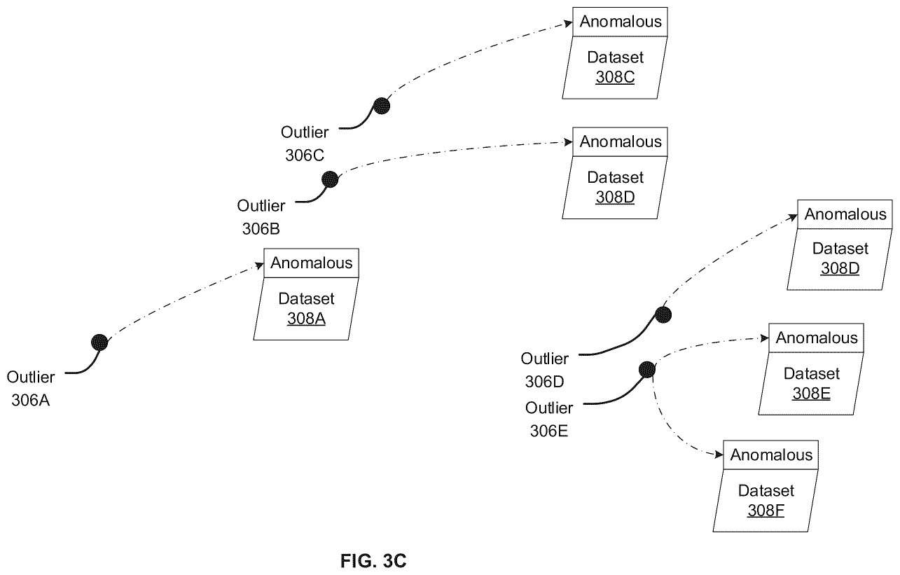

FIG. 3A shows the application of a clustering algorithm 302 to a set of datapoints 300 representing vulnerability parameter values, according to some embodiments of the technology described herein. For example, the datapoints may be generated using the technique described herein with reference to FIG. 2. In some embodiments, the clustering algorithm 302 may be applied to the datapoints by vulnerability data processing system 120 described herein with reference to FIGS. 1A-1B as part of identifying anomalous vulnerability data (e.g., in one or more datasets acquired by a vulnerability data acquisition agent).

In the example of FIG. 3A, the datapoints 300 are represented as dots. In some embodiments, the datapoints may each be a set of numerical values. For example, the datapoints may be numerical vectors (e.g., generated by a trained encoder model). As another example, that datapoints may be numerical matrices.

The clustering algorithm 302 applied to the datapoints 300 may be any suitable clustering algorithm. In some embodiments, the clustering algorithm 302 may be a density-based clustering algorithm. For example, the clustering algorithm 302 may be a density-based clustering of applications with noise (DBSCAN) clustering algorithm. To illustrate, the DBSCAN clustering algorithm may be the DBSCAN algorithm described in “A density-based algorithm for discovering clusters in large spatial databases with noise” published in Proceedings of the Second International Conference on Knowledge Discovery and Data Mining (KDD'96) by AAAI Press, pp 226-231 in 1996. In some embodiments, the density-based clustering algorithm may be a hierarchical density-based spatial clustering (HDBSCAN) algorithm. For example, the density-based clustering algorithm may be the HDBSCAN algorithm described in “Density-Based Clustering Based on Hierarchical Density Estimates,” published in Advances in Knowledge Discovery and Data Mining (PAKDD 2013) in Lecture Notes in Computer Science, vol 7819 by Springer, Berlin, Heidelberg in 2013, which is incorporated by reference herein. In some embodiments, the clustering algorithm 302 may be a k-means clustering algorithm, a Gaussian Mixture Model algorithm, a balance iterative reducing and clustering (BIRCH) algorithm, an affinity propagation clustering algorithm, a mean-shift clustering algorithm, an ordering points to identify the clustering structure (OPTICS) algorithm, an agglomerative hierarchy clustering algorithm, or another suitable clustering algorithm.

FIG. 3B shows vulnerability parameter clusters obtained from the application of the clustering algorithm 302 of FIG. 3A, according to some embodiments of the technology described herein. As shown in the example of FIG. 3B, the vulnerability parameter clusters include vulnerability parameter clusters 304A, 304B, 304C. The result of applying the clustering algorithm 302 additionally includes various outlier datapoints 306A, 306B, 306C, 306D, 306E. In some embodiments, the system may be configured to identify the outlier datapoints 306A, 306B, 306C, 306D, 306E by identifying datapoints that do not belong to any of the vulnerability parameter clusters 304A, 304B, 304C. For example, the system may identify the outlier datapoints 306A, 306B, 306C, 306D, 306E based on a cluster membership determined for each of the datapoints 300 from applying the clustering algorithm 302. In some embodiments, the system may be configured to identify the outlier datapoints based on distances of the datapoints 300 from the clusters 304A, 304B, 304C. For example, the system may be configured to identify the outlier datapoints 306A, 306B, 306C, 306D, 306E by: (1) determining, for each of the datapoints 300, a distance between the datapoint one of the vulnerability parameter clusters 304A, 304B, 304C that is closest to the datapoint; and (2) identifying a given datapoint as being an outlier datapoint when the distance determined for the given datapoint is greater than a threshold distance. In some embodiments, the system may be configured to identify the outlier datapoints 306A, 306B, 306C, 306D. 306E by: (1) identifying clusters that are less than a threshold size or density; and (2) identify datapoints in the identified clusters as outlier datapoints.

In some embodiments, the system may be configured to assign a label to each datapoint indicating its cluster membership. For example, the system may label datapoints belonging to cluster 304A with a value of 1, datapoints belonging to cluster 304B with a value of 2, datapoints belonging to cluster 304C with a value of 3, and outlier datapoints with a value of −1. The system may be configured to store a label for a given datapoint in association with the datapoint.

FIG. 3C illustrates the use of outlier datapoints 306A, 306B, 306C, 306D, 306E for identifying anomalous vulnerability data, according to some embodiments of the technology described herein. In some embodiments, each of the outlier datapoints 306A, 306B, 306C, 306D, 306E represents one or more vulnerability parameter values. For example, each of the outlier datapoints 306A, 306B, 306C, 306D, 306E may be generated from a respective masked value that represents a set of vulnerability parameter value(s). As shown in the example embodiment of FIG. 3C, the system uses the outlier datapoints 306A, 306B, 306C, 306D, 306E to label datasets 308A, 308B, 308C, 308D, 308E, 308F as anomalous. The system may determine that each of the datasets 308A, 308B, 308C, 308D, 308E, 308F includes vulnerability parameter value(s) represented by at least one of the outlier datapoints 306A, 306B, 306C, 306D, 306E. For example, the system may: (1) determine masked parameter values from which the outlier datapoints 306A, 306B, 306C, 306D, 306E was generated (e.g., using a trained encoder model); (2) identify parameter values represented by the masked parameter values; and (3) determine the identified parameter values to be anomalous.

As shown in the example embodiment of FIG. 3C, the system labels the datasets 308A, 308B, 308C, 308D, 308E, 308F including the anomalous vulnerability parameter values as anomalous. For example, the system may apply a metadata tag to vulnerability data files indicating that they are anomalous. In some embodiments, the system may be configured to output and indication of the datasets 308A, 308B, 308C, 308D, 308E, 308F. For example, the system may indicate the datasets 308A, 308B, 308C, 308D, 308E, 308F as anomalous in a GUI provided on a computing device.

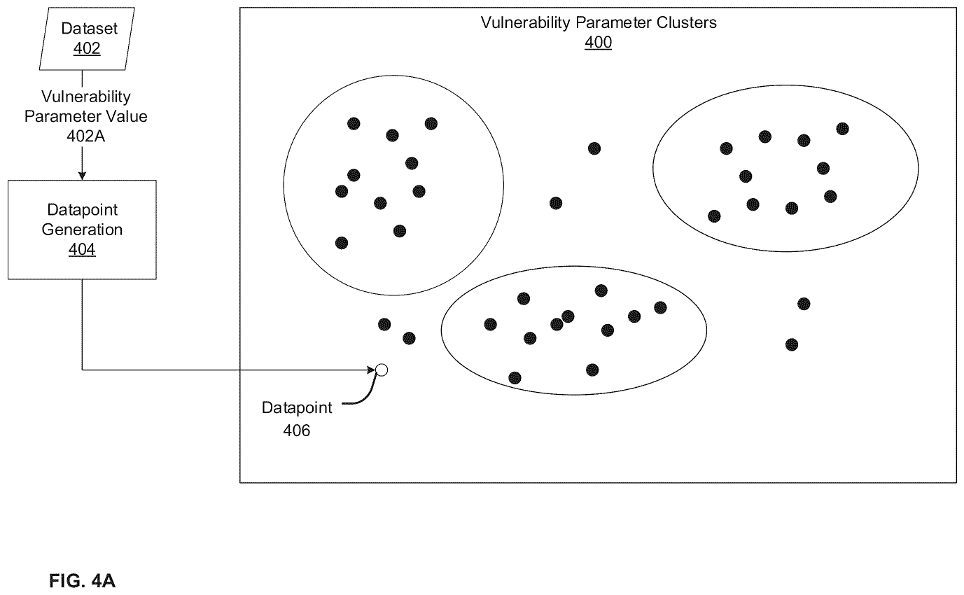

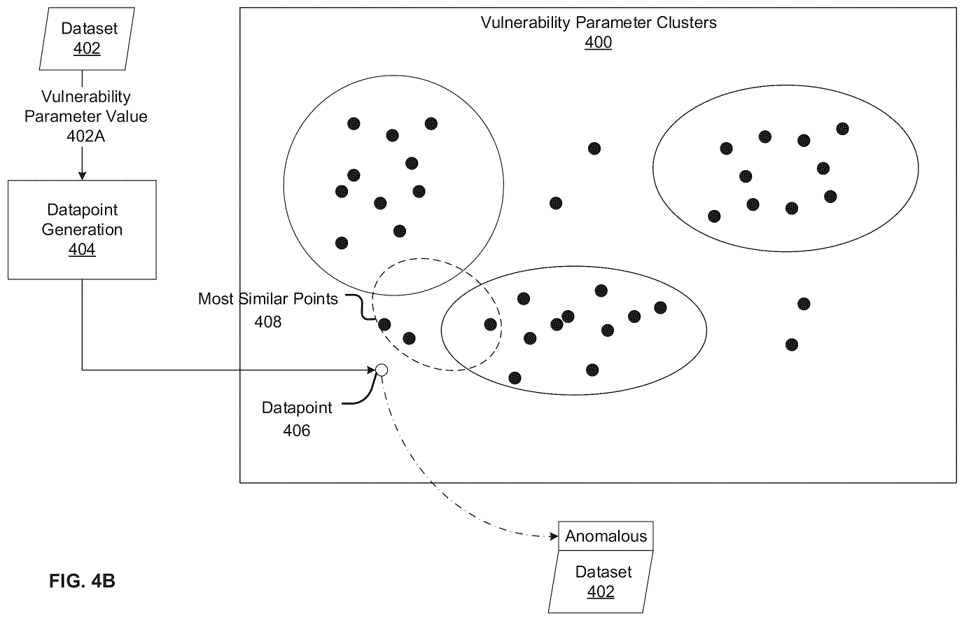

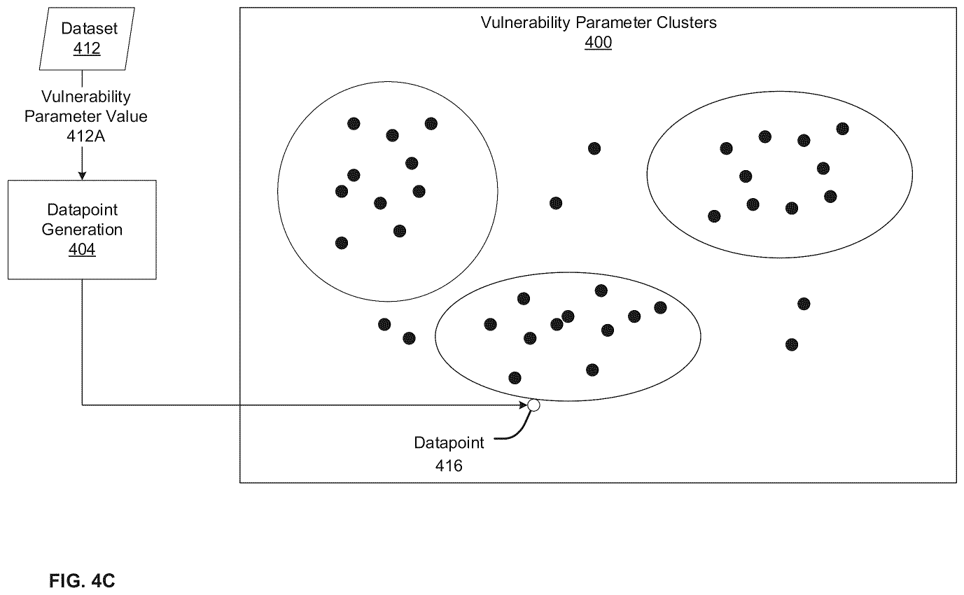

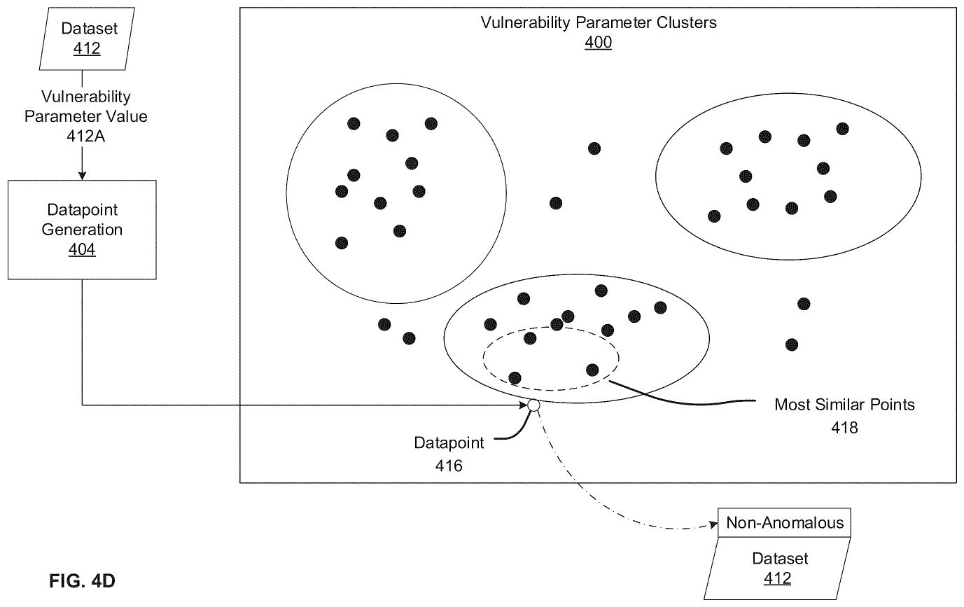

FIGS. 4A-4D illustrate the use of vulnerability parameter clusters (e.g., vulnerability parameter clusters 304A, 304B, 304C) in determining whether datasets (e.g., acquired by a vulnerability data acquisition agent) include anomalous vulnerability data, according to some embodiments of the technology described herein. In some embodiments, the technique illustrated in FIGS. 4A-4D may be used by vulnerability data processing system 120 described herein with reference to FIGS. 1A-1B to determine whether newly acquired vulnerability data is anomalous.

FIG. 4A illustrates the generation of a new datapoint 406 representing a vulnerability parameter value 402A from an acquired dataset 402, according to some embodiments of the technology described herein. In some embodiments, the datapoint generation 404 performed by the system may include: (1) masking the vulnerability parameter value 402A (e.g., using data transformation rules); and (2) providing the masked vulnerability parameter value as input to a trained encoder model (e.g., associated from a vulnerability data acquisition agent that obtained vulnerability data included in dataset 402) to obtain the datapoint 406. For example, the datapoint 406 may be a numerical vector (e.g. of the same length as numerical vectors used to determine the vulnerability parameters clusters 400).

FIG. 4B illustrates the use of the new datapoint 406 of FIG. 4A for identifying anomalous vulnerability data, according to some embodiments of the technology described herein. As shown in FIG. 4B, the system identifies a set of datapoints closest to datapoint 406. In the example of FIG. 4B, the system has identified a set of points 408 to be the datapoints that are most similar to datapoint 406 representing the vulnerability parameter value 402A. The system determines whether datapoint 406 represents an anomalous vulnerability parameter value based on the set of points 408 that are most similar to datapoint 406. In the example of FIG. 4B, the system has determined that the set of points 408 that are most similar to datapoint 406 are outlier datapoints and that datapoint 406 is thus anomalous. As illustrated in FIG. 4B, the system labels dataset 402 to be anomalous (e.g., because the system has determined that dataset 402 includes anomalous vulnerability parameter value(s)).

In some embodiments, the system may be configured to identify the points 408 that are most similar to datapoint 406 using a measure of similarity. In some embodiments, the measure of similarity may be a measure of distance. The system may be configured to determine a measure of distance between datapoint 406 and datapoints of the vulnerability parameter clusters and identify a number (e.g., 1, 2, 3, 4, 5, 6, 7, 8, 9, 10, or another suitable number) of datapoints closest to datapoint 406 to be the set of points 408. In some embodiments, the datapoint 406 and the datapoints of the vulnerability parameter clusters 400 may be numerical vectors (e.g., vectors of real values). The system may calculate the measure of distance between the numerical vector of datapoint 406 and the numerical vectors of the datapoints of the vulnerability parameter clusters 400. For example, the measure of distance may be Euclidean distance, Manhattan distance, Minkowski distance, Hamming distance, or another suitable measure of distance.

In some embodiments, the system may be configured to determine whether datapoint 406 represents an anomalous vulnerability parameter value based on points 408 by a vote. Each of points 408 may have an associated label indicating membership of the point in the vulnerability parameter clusters 400. For example, a label of 1 may indicate membership to a first cluster, a label of 2 may indicate membership to a second cluster, a label of 3 may indicate membership to a third cluster, and a label of −1 may indicate that the point does not belong to any cluster. In some embodiments, the system may be configured to determine a label for datapoint 406 to be a label shared by a majority of points 408. In some embodiments, the system may be configured to determine a label for datapoint 406 to be a label shared by the greatest number of points 408. In the example of FIG. 4B, the points 408 include two outlier datapoints and one belonging to a cluster. Accordingly, the datapoint 406 is determined to be an outlier (e.g., labeled as −1).

FIG. 4C illustrates the generation of another datapoint 416 representing a vulnerability parameter value 412A from an acquired dataset 412, according to some embodiments of the technology described herein. In some embodiments, the datapoint generation 404 performed by the system may include: (1) masking the vulnerability parameter value 412A (e.g., using data transformation rules); and (2) providing the masked vulnerability parameter value as input to a trained encoder model (e.g., associated from a vulnerability data acquisition agent that obtained vulnerability data included in dataset 402) to obtain the datapoint 416. For example, the datapoint 406 may be a numerical vector (e.g. of the same length as numerical vectors used to determine the vulnerability parameters clusters 400).

FIG. 4D illustrates the use of datapoint 416 of FIG. 4C to determine that vulnerability dataset 412 is non-anomalous, according to some embodiments of the technology described herein. As shown in FIG. 4D, the system has identified a set of points 418 to be the most similar (e.g., closest in distance) to datapoint 416. Example techniques that may be used to identify the points 418 most similar to datapoint 416 are described herein with reference to FIG. 4B. The system may be configured to determine whether datapoint 416 represents an anomalous vulnerability parameter value based on the points 418 most similar to datapoint 416. Example techniques that may be used to determine whether datapoint 416 represents an anomalous vulnerability parameter based on the points 418 are described herein with reference to FIG. 4B. For example, the system may use majority voting among the points 418 to determine a label for datapoint 416. In the example of FIG. 4D, the system has determined that datapoint 416 does not represent an anomalous vulnerability parameter value because each of datapoints 418 belongs to a vulnerability parameter cluster indicating that it represents a non-anomalous vulnerability parameter value. Accordingly, the system does not determine datapoint 416 to represent an anomalous vulnerability parameter and thus determines dataset 412 to be non-anomalous. For example, as shown in FIG. 4D, the system labels dataset 412 as non-anomalous (e.g., by setting a value of a metadata field associated with dataset 412).

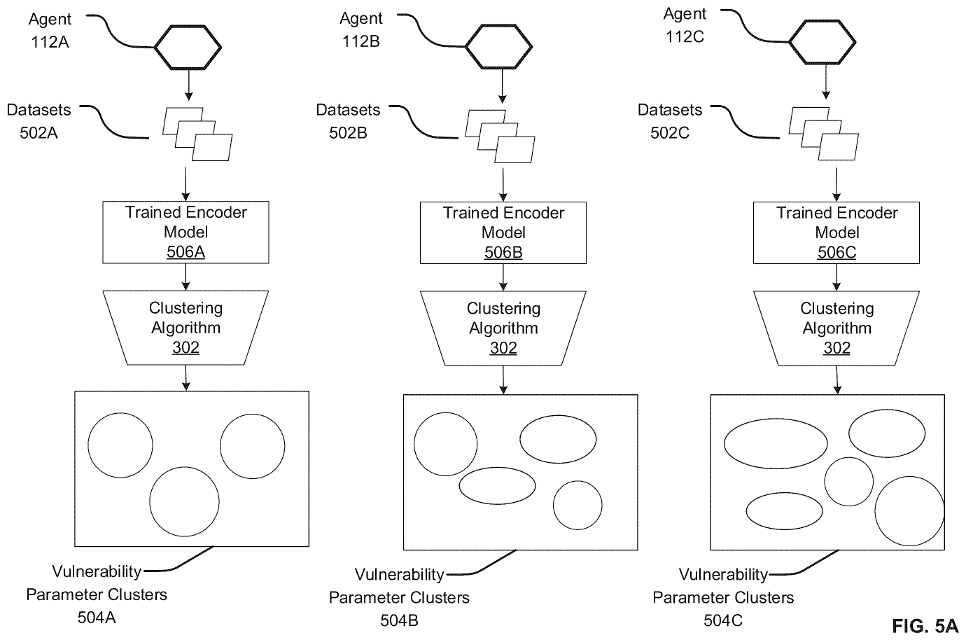

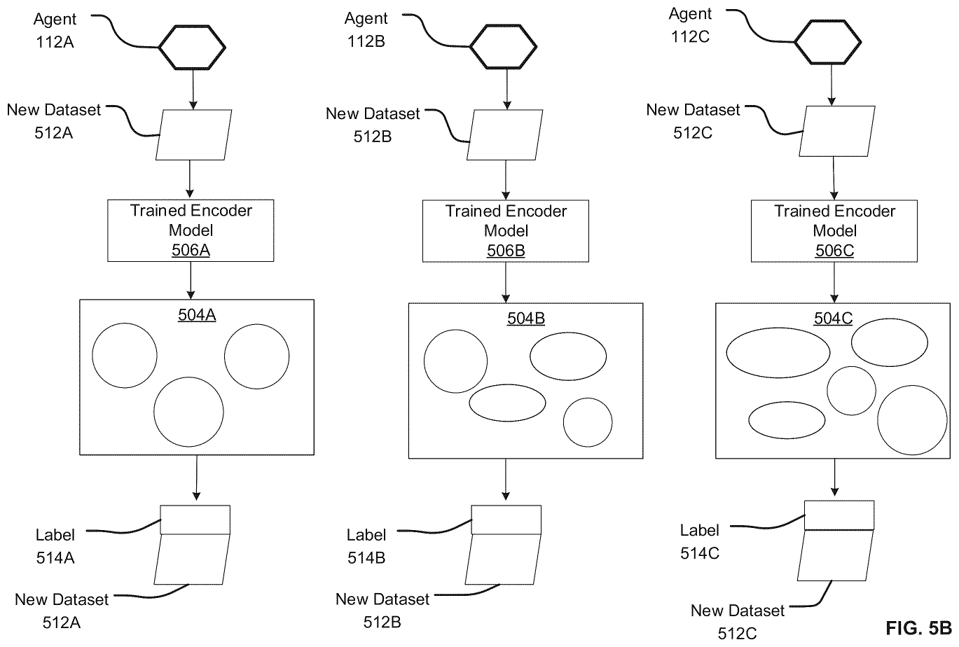

FIG. 5A illustrates the generation of a clustering model for each of multiple vulnerability data acquisition agents 112A, 112B, 112C, according to some embodiments of the technology described herein. In some embodiments, the clustering model for each of the agents 112A, 112B, 112C may be generated by the vulnerability data processing system 120 described herein with reference to FIG. 1A. As illustrated in FIG. 5A, each of the agents 112A, 112B, 112C acquires respective datasets including vulnerability data. Agent 112A acquires datasets 502A, agent 112B acquires datasets 502B, and agent 112C acquires datasets 502C. The system may be configured to generate, for each collection of datasets, a set of datapoints representing vulnerability parameter values included in the collection of datasets.

As shown in the example of FIG. 5A, in some embodiments, the system may be configured to generate a set of datapoints representing vulnerability parameter values included in a collection of datasets using a trained encoder model associated with an agent that obtained the collection of datasets. In some embodiments, the system may be configured to generate a set of data points using a trained encoder model as described herein with reference to FIG. 2. In the example of FIG. 5A, the system may be configured to generate a set of datapoints representing vulnerability values included in the collection of datasets 502A obtained by the agent 112A using a trained encoder model 506A associated with the agent 112A, the system may be configured to generate a set of datapoints representing vulnerability values included in the collection of datasets 502B obtained by the agent 112B using a trained encoder model 506B associated with the agent 112B, the system may be configured to generate a set of datapoints representing vulnerability values included in the collection of datasets 502C obtained by the agent 112C using a trained encoder model 506C associated with the agent 112C. In some embodiments, each of the trained encoder models 506A, 506B, 506C may be trained using data obtained by the respective agent that the trained encoder model is associated with. For example, the trained encoder model may be an encoder of a variational autoencoder which was trained using data obtained by an agent that obtained the data.

The system applies clustering algorithm 302 to each set of datapoints to obtain a respective set of vulnerability parameter clusters for each agent. In the example of FIG. 5A, the system obtains vulnerability parameter clusters 504A for agent 112A, vulnerability parameter clusters 504B for agent 112B, and vulnerability parameter clusters 504C for agent 112C. Each of the sets of vulnerability parameter clusters 504A, 504B, 504C is generated from vulnerability data acquired by a particular agent and thus provides a model specific to the agent.

In some embodiments, the system may be configured to update each of the sets of vulnerability parameter clusters 504A, 504B, 504C. In some embodiments, the system may be configured to periodically update each of the sets of vulnerability parameter clusters 504A, 504B, 504C. For example, the system may periodically update a set of clusters (e.g., every 1-4 weeks, 4-8 weeks, 8-12 weeks, or another suitable frequency) using the most recent collection of datasets acquired by a respective vulnerability data acquisition agent (e.g., by reapplying clustering algorithm 302 to datapoints generated from the most recent collection of datasets). As another example, the system may update a set of clusters in response to obtaining a threshold number of new datasets. As another example, the system may update a set of clusters in response to a user command.

FIG. 5B illustrates the use of the sets of vulnerability parameter clusters 504A, 504B, 504C of FIG. 5A for identifying anomalous vulnerability data obtained by the vulnerability data acquisition agents 112A, 112B, 112C, according to some embodiments of the technology described herein. As shown in FIG. 5B, agent 112A acquires new dataset 512A (e.g., generates a new XML file including vulnerability parameter value(s)), agent 112B acquires new dataset 512B, and agent 112C acquires new dataset 512C. The system determines labels 514A, 514B, 514C (e.g., anomalous or non-anomalous) for each of the new datasets 512A, 512B, 512C using a respective one of the sets of vulnerability parameter clusters 504A, 504B, 504C. The system may be configured to use a set of vulnerability parameter clusters to determine a label for a respective new dataset as described herein with reference to FIGS. 4A-4D.

As illustrated in the example embodiment of FIG. 5B, the system may be configured to use a set of vulnerability parameter clusters to determine a label for a respective new dataset by: (1) generating one or more datapoints representing one or more vulnerability parameter values included in the dataset; and (2) determining the label for the respective new dataset using the datapoint(s) and the set of vulnerability parameter clusters. Example techniques of how the system may use a set of vulnerability parameter clusters to determine a label for a new dataset is described herein with reference to FIGS. 4A-4D. The system may be configured to generate datapoint(s) representing vulnerability parameter value(s) in a dataset using a trained encoder model associated with an agent that obtained the dataset. In the example of FIG. 5B, the system uses trained encoder model 506A associated with agent 112A to generate datapoint(s) representing vulnerability parameter value(s) in new dataset 512A obtained by agent 112A, the system uses trained encoder model 506B associated with agent 112B to generate datapoint(s) representing vulnerability parameter value(s) in new dataset 512B obtained by agent 112B, and the system uses trained encoder model 506C associated with agent 112C to generate datapoint(s) representing vulnerability parameter value(s) in new dataset 512C obtained by agent 112C.

In some embodiments, the system may be configured to output an indication of vulnerability data determined to be anomalous. For example, the system may provide file names of files determined to include anomalous vulnerability parameter data (e.g., anomalous vulnerability parameter value(s)) for further investigation. In some embodiments, the system may be configured to filter out the vulnerability data determined to be anomalous (e.g., such that it is not used in configuring anomaly detection of the computer network security system 110 described herein with reference to FIG. 1A).

In some embodiments, the system may be configured to use the cluster models for the agents 112A, 112B, 112C in an executable software service that identifies anomalous vulnerability data. The system may be configured to package the sets of vulnerability parameter clusters 504A, 504B, 504C into the service. The system may be configured to execute the software service in response to the acquisition of a new dataset by one of the agents 112A, 112B, 112C. The system may be configured to send dataset(s) (e.g., file(s)) as input to the service to receive an indication of dataset(s) that include anomalous vulnerability data.

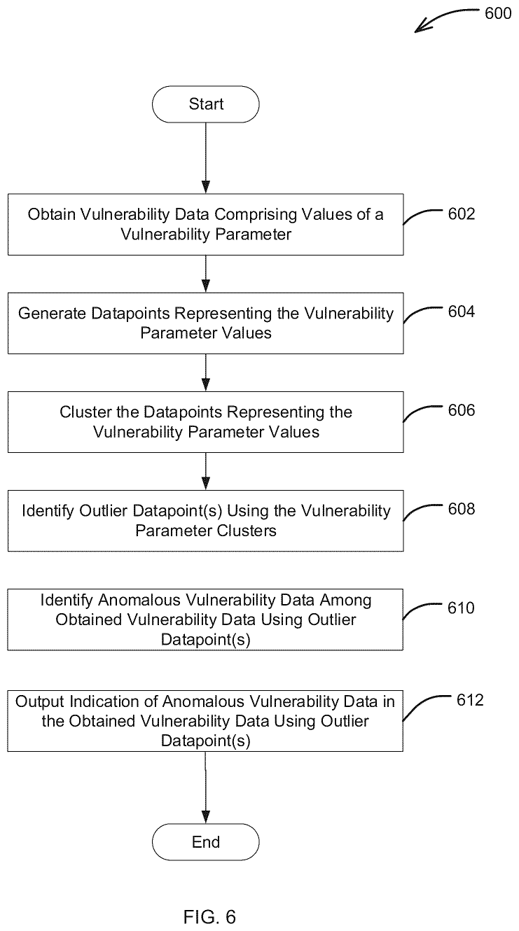

FIG. 6 is a flowchart of an example process 600 of identifying anomalous vulnerability data among vulnerability data, according to some embodiments of the technology described herein. In some embodiments, process 600 may be performed by vulnerability data processing system 120 described herein with reference to FIGS. 1A-1B. For example, process 600 may be performed by the vulnerability data processing system 120 as part of acquiring vulnerability data for configuring vulnerability detection of the computer network security system 110 described herein with reference to FIG. 1A.

Process 600 begins at block 602, where the system obtains vulnerability data comprising values of a vulnerability parameter (also referred to herein as “vulnerability parameter values”). In some embodiments, the vulnerability parameter can be used to configure of detection of one or more vulnerabilities in a cloud computing environment by a computer network security system (e.g., computer network security system 110 described herein with reference to FIG. 1A). For example, the vulnerability parameter may be a software version identifier for a software application that is executable by one or more VMs in the cloud computing environment (e.g., by instantiating the VM(s) on computing resources of the cloud computing environment). In some embodiments, the system may be configured to obtain the vulnerability data by: (1) obtaining vulnerability parameter values; and (2) storing the vulnerability parameter values in datasets. For example, the system may store obtained vulnerability parameter values as values of fields in one or more files (e.g., XML file(s)).

In some embodiments, the system may be configured to obtain the vulnerability data from one or more vulnerability data sources. For example, the system may obtain the vulnerability data from an Internet website that provides vulnerability data for a particular software application. As another example, the system may obtain the vulnerability data from an online repository (e.g., a database) storing vulnerability data for a software application. In some embodiments, the system may be configured to obtain the vulnerability data as user input. For example, the system may receive the vulnerability data through a GUI.

In some embodiments, the system may be configured to obtain the vulnerability data using a vulnerability data acquisition agent (e.g., one of agents 112A, 112B, 112C described herein with reference to FIG. 1A). The system may be configured to execute the agent to extract the vulnerability data from the vulnerability data source(s). The agent, when executed, may access the vulnerability data from the vulnerability data source(s). For example, the agent may access the vulnerability data by scraping an Internet website to obtain the vulnerability data. As another example, the agent may transmit one or more requests (e.g., one or more queries) through an API to obtain the vulnerability data.

Next, process 600 proceeds to block 604, where the system generates datapoints representing the vulnerability parameter values. An example technique that may be used by the system to generate the datapoints representing the vulnerability parameter values is described herein with reference to FIG. 2. For example, the system may generate the datapoints by: (1) deduplicating the vulnerability parameter values to obtain deduplicated vulnerability parameter values (e.g., a set of unique vulnerability parameter values); (2) masking the deduplicated vulnerability parameter values to obtain masked vulnerability parameters; (3) deduplicating the masked vulnerability parameters to obtain deduplicated masked vulnerability parameter values (e.g., unique masked vulnerability parameter values); and (4) providing the deduplicated masked vulnerability parameter values as input to a trained encoder model to obtain corresponding outputs (e.g., numerical vectors) as the datapoints. In some embodiments, the system may be configured to provide the deduplicated vulnerability parameter values as input to the trained encoder to obtain corresponding outputs as the datapoints (i.e., without masking the deduplicated vulnerability parameter values and deduplicating the masked vulnerability parameter values).

Next, process 600 proceeds to block 606 in which the system clusters the datapoints representing the vulnerability parameter values to obtain vulnerability parameter clusters. Example techniques that may be used by the system to cluster the datapoints are described herein with reference to FIG. 3A. In some embodiments, the system may be configured to label each of the datapoints to indicate its membership among the vulnerability parameter clusters. For example, each vulnerability parameter cluster may be associated with a particular integer value and the system may label each datapoint with an integer value associated with the vulnerability parameter cluster to which the datapoint belongs. In some embodiments, the system may be configured to label datapoints that do not belong to a vulnerability parameter cluster with a respective label (e.g., a particular integer value).

Next, process 600 proceeds to block 608, where the system identifies one or more outlier datapoints using the vulnerability parameter clusters. Example techniques that may be used by the system to identify the outlier datapoint(s) are described herein with reference to FIG. 3B. For example, the system may identify one or more datapoints that do not belong to a vulnerability parameter cluster (e.g., based on labels associated with the datapoint(s)) to be the outlier datapoint(s). As another example, the system may identify one or more datapoints that are more than a threshold distance away from the nearest vulnerability parameter cluster to be the outlier datapoint(s). Example measures of distance are described herein. As another example, the system may identify one or more datapoints belonging to vulnerability parameter cluster(s) with less than a threshold density of datapoints to be the outlier datapoint(s).

In some embodiments, the system may be configured to use the outlier datapoint(s) as indications that vulnerability parameter value(s) represented by the outlier datapoint(s) are anomalous. Each of the outlier datapoint(s) may indicate one or more anomalous vulnerability parameter values. For example, an outlier datapoint may correspond to a masked vulnerability parameter value from which the outlier datapoint was generated (e.g., using a trained encoder model). The masked vulnerability parameter value may be a masking of one or more vulnerability parameter values that were included in the obtained vulnerability parameter. The system may determine these vulnerability parameter value(s) to be anomalous.

Next, process 600 proceeds to block 610, where the system identifies anomalous vulnerability data among the vulnerability data obtained at block 602 using the outlier datapoint(s). In some embodiments, the system may be configured to identify dataset(s) in the vulnerability data including anomalous vulnerability parameter value(s) indicated by the outlier datapoint(s) to be anomalous vulnerability data. The system may be configured to label the identified dataset(s) as anomalous vulnerability data. For example, the system may identify XML file(s) that include anomalous vulnerability parameter value(s) indicated by the outlier datapoint(s) to be anomalous. In some embodiments, the system may be configured to identify the anomalous vulnerability parameter value(s) indicated by the outlier datapoint(s) in the vulnerability data. The system may be configured to label the identified anomalous vulnerability parameter value(s) (e.g., by marking the value(s) in the vulnerability data).

Next, process 600 proceeds to block 612, where the system outputs an indication of anomalous vulnerability data among the vulnerability data obtained at block 602. In some embodiments, the system may be configured to output an indication of the anomalous vulnerability data by outputting an indication of one or more datasets in the vulnerability data as anomalous vulnerability data. For example, the system may assign a metadata field value associated with the dataset(s) with a value indicating that the dataset(s) are anomalous. In some embodiments, the system may be configured to output an indication of the anomalous vulnerability data by outputting anomalous vulnerability parameter value(s) (e.g., indicated by the outlier datapoint(s)).

In some embodiments, the system may be configured to output an indication of the anomalous vulnerability data to a user device. For example, the system may output an indication of anomalous vulnerability data (e.g., one or more datasets) in a GUI displayed by the user device. As another example, the system may transmit a message to a user device indicating anomalous vulnerability data. As another example, the system may display a visualization of anomalous vulnerability data in a GUI (e.g., by providing a listing of anomalous vulnerability parameter values or providing a graphical depiction of the anomalous vulnerability data).

In some embodiments, the system may be configured to filter the identified anomalous vulnerability data from the obtained vulnerability data. The system may be configured to filter out the anomalous vulnerability data for further investigation (e.g., by a user). The system may be configured to provide the filtered vulnerability data to a computer network security system (e.g., computer network security system 110) for configuring its vulnerability detection. For example, the system may provide a filtered set of software version identifier values to the computer network security system for configuring its detection of a vulnerability in a software application.

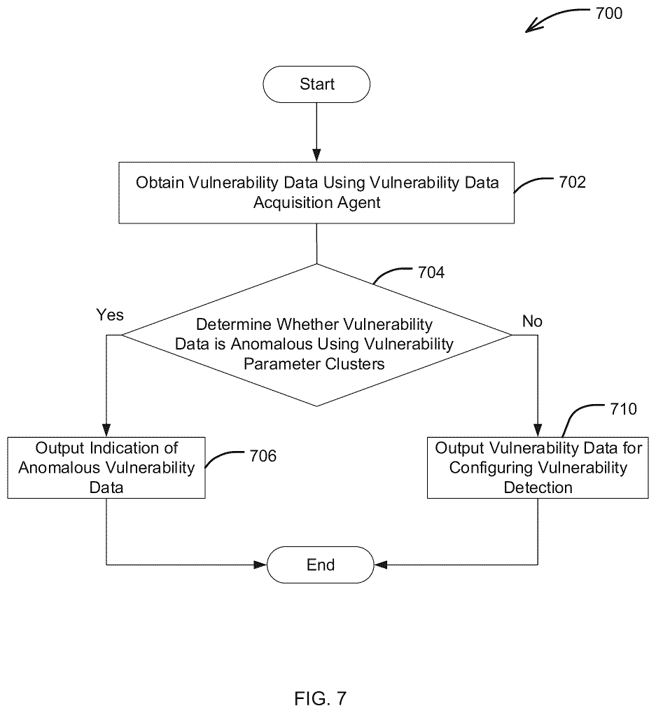

FIG. 7 is a flowchart of an example process 700 of determining whether acquired vulnerability data is anomalous, according to some embodiments of the technology described herein. In some embodiments, process 700 may be performed by vulnerability data processing system 120 described herein with reference to FIGS. 1A-1B. In some embodiments, process 700 may be performed by the system after performing process 600 described herein with reference to FIG. 6. For example, the system may perform process 600 to obtain vulnerability parameter clusters for a respective vulnerability data acquisition agent. The system may perform process 700 to determine whether newly acquired vulnerability data is anomalous.

Process 700 begins at block 702, where the system obtains vulnerability data using a vulnerability data acquisition agent (e.g., one of agents 112A, 112B, 112C described herein with reference to FIG. 1A). Example techniques of obtaining vulnerability data are described here with reference to block 602 of process 600 described herein with reference to FIG. 6. For example, the system may obtain a dataset (e.g., an XML file) including one or more vulnerability parameter values.

Next, process 700 proceeds to block 704, where the system determines whether the vulnerability data obtained at block 702 is anomalous using vulnerability parameter clusters (e.g., obtained at block 606 of process 600). Example techniques that may be used by the system to determine whether the vulnerability data is anomalous are described herein with reference to FIGS. 4A-4D. For example, the system may determine whether the vulnerability data is anomalous using the vulnerability parameter clusters by: (1) identifying a vulnerability parameter value included in the vulnerability data; (2) generating a datapoint representing the vulnerability parameter value; (3) determining a set of clustered datapoints that are most similar to the datapoint representing the vulnerability parameter value from the vulnerability data (e.g., by determining a set of the closest datapoints); and (4) determining whether the vulnerability parameter value is anomalous based on the set of clustered datapoints. For example, the system may determine whether the vulnerability parameter value is anomalous based on whether a majority of the most similar clustered datapoints are outliers. When a majority of the most similar datapoints are outliers, the system may determine the vulnerability parameter value to be anomalous. Otherwise, the system may determine the vulnerability parameter to be non-anomalous.

If at block 704 the system determines that the vulnerability data is anomalous, then process 700 proceeds to block 706, where the system outputs an indication of the anomalous vulnerability data. Example techniques for outputting an indication of the anomalous vulnerability data are described herein with reference to block 610 of process 600. For example, the system may output an indication of the anomalous vulnerability data to a user device for further investigation. In some embodiments, the system may be configured to prevent the anomalous vulnerability data from being used to configure anomaly detection of a computer network security system (e.g., by withholding the anomalous vulnerability data from the computer network security system).

If at block 704 the system determines that the vulnerability data is not anomalous, then process 700 proceeds to block 710, where the system outputs the vulnerability data for configuring vulnerability detection of a computer network security system (e.g., computer network security system 110 described herein with reference to FIG. 1A). For example, the system may output the vulnerability data for use by the computer network security system in configuring detection of a vulnerability in a software application executable in a cloud computing environment in which the computer network security system operates. In one example implementation, the computer network security system may use the vulnerability data to configure vulnerability detection in a software application that is executable by one or more VMs in the cloud computing environment.

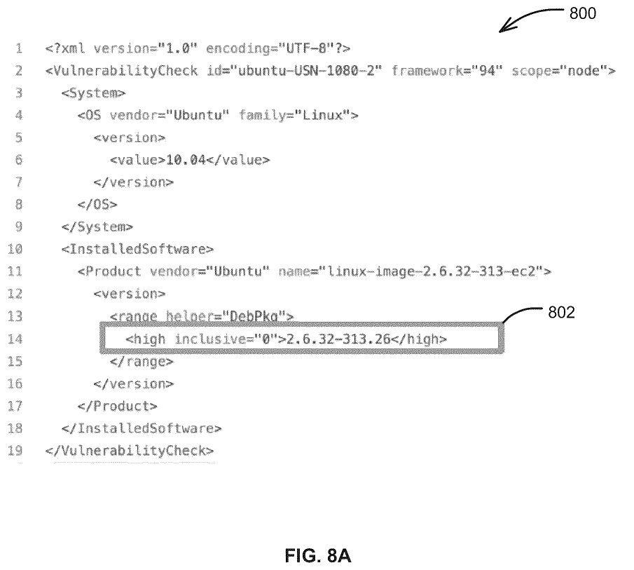

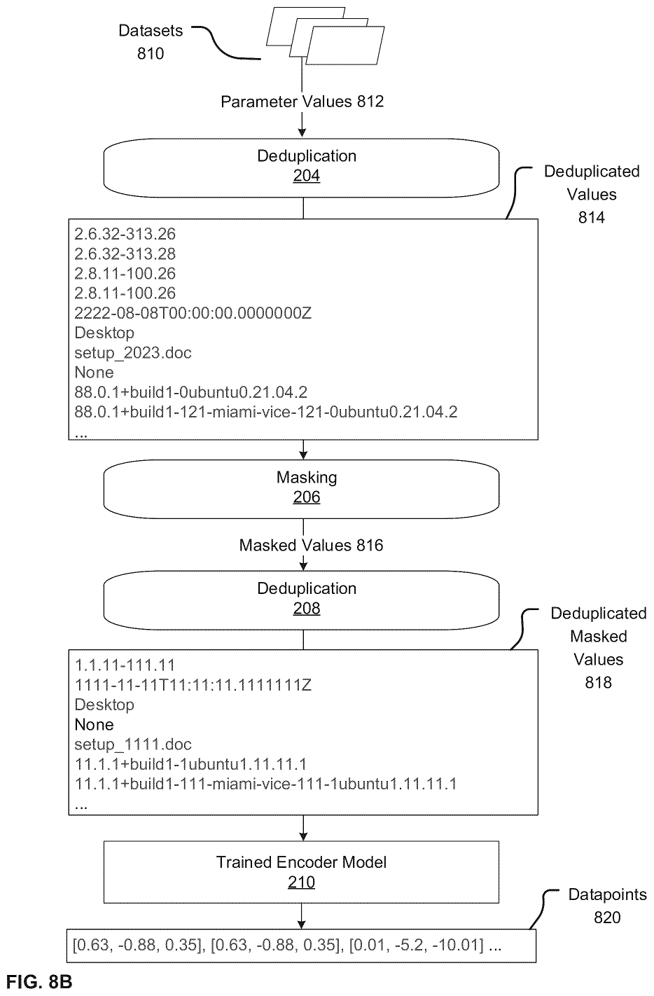

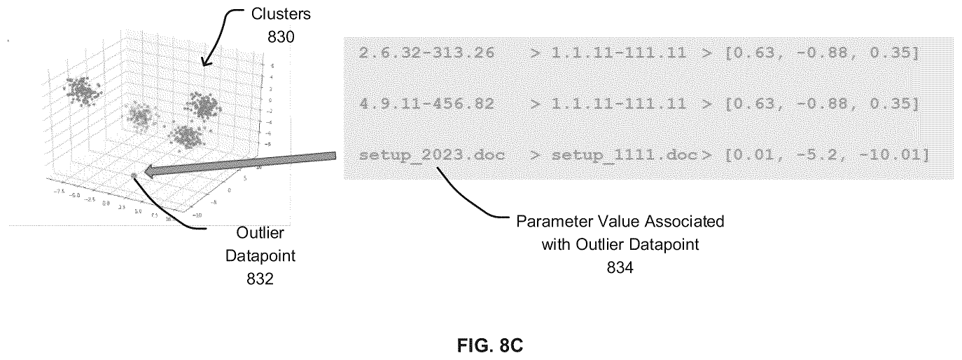

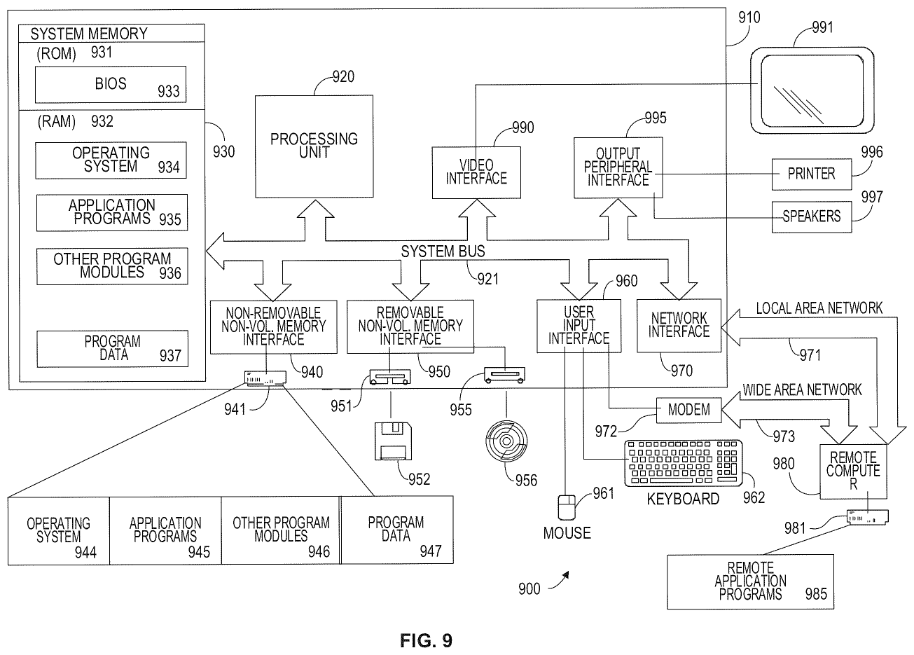

FIG. 8A is an example dataset 800 including a vulnerability parameter value, according to some embodiments of the technology described herein. In the example of FIG. 9A, the dataset is an XML file which includes value 802 of a software version identifier. As shown in the example of FIG. 8A, the value 802 is stored in a field of the dataset 800. In some embodiments, the dataset 800 may be obtained by the vulnerability data processing system 120 described herein with reference to FIGS. 1A-1B (e.g., as described at block 602 of process 600 described herein with reference to FIG. 6). For example, the dataset 800 may be generated by a vulnerability data acquisition agent of the vulnerability data processing system 120.

FIG. 8B is an example of generating datapoints 820 using vulnerability parameter values 812 extracted from datasets 810, according to some embodiments of the technology described herein. For example, the generation of datapoints 820 illustrated in FIG. 8B may be performed at block 604 of process 600. As shown in FIG. 9B, the datapoints 820 are generated using the technique illustrated in FIG. 2. The system deduplicates 204 the vulnerability parameter values 812 to obtain deduplicated vulnerability parameter values 814 (e.g., a unique set of vulnerability parameter values). The system masks 206 the deduplicated vulnerability parameter values to obtain masked vulnerability parameter values and then deduplicates 208 the masked vulnerability parameter values to obtain the deduplicated masked vulnerability parameter values 818 (e.g., a unique set of masked vulnerability parameter values). The system passes each of the deduplicated masked vulnerability parameter values 812 as input to the trained encoder model 210 to obtain the datapoints 820. The datapoints 820 include a vector representing each of the deduplicated masked vulnerability parameter values 818.

FIG. 8C is an example set of vulnerability parameter clusters 830 obtained from applying a clustering algorithm to the datapoints 820 generated in FIG. 8B, according to some embodiments of the technology described herein. In the example of FIG. 8C, the set of vulnerability parameter clusters 830 includes three clusters. The system identifies the datapoint 832 as an outlier. The outlier 832 is associated with the vulnerability parameter value 834 which is the following string “setup_2023.doc”. The system may determine the vulnerability parameter value to be anomalous (e.g., as described at block 608 of process 600). The system may be configured to output an indication of the anomalous vulnerability parameter value. For example, the system may label one or more of the datasets 810 that include the parameter value 834 as anomalous vulnerability data.

FIG. 9 shows a block diagram of an exemplary computing device, in accordance with some embodiments of the technology described herein. The computing system environment 900 is only one example of a suitable computing environment and is not intended to suggest any limitation as to the scope of use or functionality of the technology described herein.

The technology described herein is operational with numerous other general purpose or special purpose computing system environments or configurations. Examples of well-known computing systems, environments, and/or configurations that may be suitable for use with the technology described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The technology described herein may also be practiced in distributed computing environments where tasks are performed by remote processing devices that are linked through a communications network. In a distributed computing environment, program modules may be located in both local and remote computer storage media including memory storage devices.

With reference to FIG. 9, an exemplary system for implementing the technology described herein includes a general purpose computing device in the form of a computer 910. Components of computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 910 typically includes a variety of computer readable media. Computer readable media can be any available media that can be accessed by computer 910 and includes both volatile and nonvolatile media, removable and non-removable media. By way of example, and not limitation, computer readable media may comprise computer storage media and communication media. Computer storage media includes volatile and nonvolatile, removable, and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 910. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs 935, other program modules 936, and program data 937.

The computer 910 may also include other removable/non-removable, volatile or nonvolatile computer storage media. By way of example only, FIG. 9 illustrates a hard disk drive 941 that reads from or writes to non-removable, nonvolatile magnetic media, a flash drive 951 that reads from or writes to a removable, nonvolatile memory 952 such as flash memory, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media described above and illustrated in FIG. 9, provide storage of computer readable instructions, data structures, program modules and other data for the computer 910. In FIG. 9, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. An actor may enter commands and information into the computer 910 through input devices such as a keyboard 962 and pointing device 961, commonly referred to as a mouse, trackball, or touch pad. Other input devices (not shown) may include a microphone, joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. In addition to the monitor, computers may also include other peripheral output devices such as speakers 997 and printer 996, which may be connected through an output peripheral interface 995.

The computer 910 may operate in a networked environment using logical connections to one or more remote computers, such as a remote computer 980. The remote computer 980 may be a personal computer, a server, a router, a network PC, a peer device, or other common network node, and typically includes many or all of the elements described above relative to the computer 910, although only a memory storage device 981 has been illustrated in FIG. 9. The logical connections depicted in FIG. 9 include a local area network (LAN) 971 and a wide area network (WAN) 973, but may also include other networks. Such networking environments are commonplace in offices, enterprise-wide computer networks, intranets, and the Internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. The modem 972, which may be internal or external, may be connected to the system bus 921 via the actor input interface 960, or other appropriate mechanism. In a networked environment, program modules depicted relative to the computer 910, or portions thereof, may be stored in the remote memory storage device. By way of example, and not limitation, FIG. 9 illustrates remote application programs 985 as residing on memory device 981. It will be appreciated that the network connections shown are exemplary and other means of establishing a communications link between the computers may be used.

Having thus described several aspects of at least one embodiment of the technology described herein, it is to be appreciated that various alterations, modifications, and improvements will readily occur to those skilled in the art. Such alterations, modifications, and improvements are intended to be part of this disclosure, and are intended to be within the spirit and scope of disclosure. Further, though advantages of the technology described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software, or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Further, it should be appreciated that a computer may be embodied in any of a number of forms, such as a rack-mounted computer, a desktop computer, a laptop computer, a tablet computer, a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, aspects of the technology described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments described above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the technology as described above. A computer-readable storage medium includes any computer memory configured to store software, for example, the memory of any computing device such as a smart phone, a laptop, a desktop, a rack-mounted computer, or a server (e.g., a server storing software distributed by downloading over a network, such as an app store)). As used herein, the term “computer-readable storage medium” encompasses only a non-transitory computer-readable medium that can be considered to be a manufacture (i.e., article of manufacture) or a machine. Alternatively, or additionally, aspects of the technology described herein may be embodied as a computer readable medium other than a computer-readable storage medium, such as a propagating signal.

The terms “program” or “software” are used herein in a generic sense to refer to any type of computer code or set of processor-executable instructions that can be employed to program a computer or other processor to implement various aspects of the technology as described above. Additionally, it should be appreciated that according to one aspect of this embodiment, one or more computer programs that when executed perform methods of the technology described herein need not reside on a single computer or processor, but may be distributed in a modular fashion among a number of different computers or processors to implement various aspects of the technology described herein.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the technology described herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the technology described herein may be embodied as a method, of which examples are provided herein including with reference to FIGS. 6 and 7. The acts performed as part of any of the methods may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B.” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method of using machine learning (ML) to identify anomalous vulnerability data among vulnerability data acquired for configuring vulnerability detection of a computer network security system configured to monitor a computing environment, the method comprising:
using at least one computer hardware processor to perform:
obtaining vulnerability data comprising a plurality of values of a vulnerability parameter, wherein the vulnerability parameter can be used to configure detection of at least one vulnerability in the computing environment by the computer network security system;
generating a plurality of datapoints representing the plurality of values of the vulnerability parameter;
clustering the plurality of datapoints to obtain a plurality of vulnerability parameter clusters;
identifying at least one outlier datapoint using the plurality of vulnerability parameter clusters, the at least one outlier datapoint indicating at least one anomalous value of the vulnerability parameter;
identifying anomalous vulnerability data among the obtained vulnerability data using the at least one outlier datapoint indicating the at least one anomalous value of the vulnerability parameter; and
outputting an indication of the anomalous vulnerability data.

2. The method of claim 1, wherein generating the plurality of datapoints representing the plurality of values of the vulnerability parameter comprises:
deduplicating the plurality of values of the vulnerability parameter to obtain a set of deduplicated vulnerability parameter values; and
generating the plurality of datapoints using the set of deduplicated vulnerability parameter values.

3. The method of claim 2, wherein generating the plurality of datapoints using the set of deduplicated vulnerability parameter values comprises:
applying a mask to the set of deduplicated vulnerability parameter values to obtain a plurality of masked vulnerability parameter values;
deduplicating the plurality of masked vulnerability parameter values to obtain a set of deduplicated masked vulnerability parameter values; and
generating the plurality of datapoints using the set of deduplicated masked vulnerability parameter values.

4. The method of claim 3, wherein generating the plurality of datapoints using the set of deduplicated masked vulnerability parameter values comprises:
encoding each of the set of deduplicated masked vulnerability parameter values as a respective fixed-length vector of numeric values to obtain a plurality of fixed-length vectors as the plurality of datapoints.

5. The method of claim 4, wherein encoding each of the set of deduplicated masked vulnerability parameter values as a respective fixed-length vector of numeric values comprises providing each of the set of deduplicated masked vulnerability parameter values as input to a trained encoder model to obtain the respective fixed-length vector of numeric values.

6. The method of claim 1, wherein obtaining the plurality of values of the vulnerability parameter comprises executing a vulnerability data acquisition agent that extracts the plurality of values of the vulnerability parameter from a vulnerability data source.

7. The method of claim 1, wherein clustering the plurality of datapoints to obtain the vulnerability parameter clusters comprises clustering the plurality of datapoints using a density-based clustering algorithm.

8. The method of claim 7, wherein the density-based clustering algorithm is a density-based spatial clustering of applications with noise (DBSCAN) algorithm.

9. The method of claim 1, further comprising:
obtaining an additional value of the vulnerability parameter;
generating an additional datapoint representing the additional value of the vulnerability parameter;
determining a measure of similarity between the additional datapoint and the plurality of datapoints; and
determining cluster membership of the additional datapoint based on the measure of similarity between the additional datapoint and the plurality of datapoints.

10. The method of claim 9, wherein the method further comprises:
determining, based on the cluster membership of the additional datapoint, that the additional datapoint is an outlier that is outside of the plurality of vulnerability parameter clusters; and
outputting an indication that the additional value of the vulnerability parameter is an anomalous value.

11. The method of claim 1, further comprising:
filtering out the at least one anomalous value of the vulnerability parameter from the plurality of values of the vulnerability parameter to obtain a filtered set of values of the vulnerability parameter; and
configuring the computer network security system to monitor at least one software application for the at least one vulnerability using the filtered set of values of the vulnerability parameter.

12. The method of claim 11, wherein configuring the computer network security system to monitor the at least one software application for the at least one vulnerability associated using the filtered set of values of the vulnerability parameter comprises configuring the computer network security system to:
determine whether the at least one software application is configured in accordance with at least one of the filtered set of values; and
when it is determined that the at least one software application is configured in accordance with the at least one filtered value,
update the at least one software application and/or apply a control to the at least one software application to compensate for the at least one vulnerability.

13. The method of claim 1, further comprising, after clustering the plurality of datapoints to obtain the plurality of vulnerability parameter clusters:
obtaining additional vulnerability data comprising additional values of the vulnerability parameter;
generating an updated plurality of datapoints representing the updated plurality of values of the vulnerability parameter;
applying the clustering algorithm to the updated plurality of datapoints to obtain an updated plurality of vulnerability clusters; and
using the updated plurality of vulnerability clusters to identify datasets including anomalous data.

14. The method of claim 1, further comprising:
executing a plurality of vulnerability data acquisition agents to obtain vulnerability parameter values;
for each agent of the plurality of vulnerability data acquisition agents:
generating a set of datapoints representing vulnerability parameter values obtained from execution of the agent;
clustering the set of datapoints to obtain a respective plurality of vulnerability parameter clusters; and
using the respective plurality of vulnerability parameter clusters to identify datasets obtained from subsequent execution of the agent that include anomalous data.

15. The method of claim 14, wherein generating the set of datapoints representing the vulnerability parameter values obtained from execution of the agent comprises:
generating a set of masked vulnerability parameter values using the vulnerability parameter values obtained from execution of the agent;
providing the set of masked vulnerability parameter values as input to the trained encoder model associated with the agent to obtain the set of datapoints; and
using a trained encoder model associated with the agent to generate the datapoints.

16. The method of claim 1, further comprising:
executing a first vulnerability data acquisition agent to obtain first vulnerability data including a first vulnerability parameter value;
executing a second vulnerability data acquisition agent to obtain second vulnerability data including a second vulnerability parameter value;
generating a first datapoint representing the first vulnerability parameter value using a first trained encoder model associated with the first vulnerability data acquisition agent; and
generating a second datapoint representing the second vulnerability parameter value using a second trained encoder model associated with the second vulnerability data acquisition agent.

17. The method of claim 1, the vulnerability parameter is a version number of a software application program.

18. The method of claim 1, wherein:
the plurality of values of the vulnerability parameter is a plurality of strings and the plurality of datapoints is a plurality of fixed-length numeric vectors representing respective ones of the plurality of strings; and
generating the plurality of datapoints representing the plurality of values of the vulnerability parameter comprises generating the plurality of fixed-length numeric vectors.

19. A vulnerability data processing system comprising:
at least one computer hardware processor; and
at least one non-transitory computer-readable storage medium storing instructions that, when executed by the at least one computer hardware processor, causes the at least one computer hardware processor to perform a method of using machine learning (ML) to identify anomalous vulnerability data among vulnerability data acquired for configuring vulnerability detection of a computer network security system configured to monitor a computing environment, the method comprising:
obtaining vulnerability data comprising a plurality of values of a vulnerability parameter, wherein the vulnerability parameter can be used to configure detection of at least one vulnerability in the computing environment by the computer network security system;
generating a plurality of datapoints representing the plurality of values of the vulnerability parameter;
clustering the plurality of datapoints to obtain a plurality of vulnerability parameter clusters;
identifying at least one outlier datapoint using the plurality of vulnerability parameter clusters, the at least one outlier datapoint indicating at least one anomalous value of the vulnerability parameter;
identifying anomalous vulnerability data among the obtained vulnerability data using the at least one outlier datapoint indicating the at least one anomalous value of the vulnerability parameter; and
outputting an indication of the anomalous vulnerability data.

20. At least one non-transitory computer-readable storage medium storing instructions that, when by at least one computer hardware processor, cause the at least one computer hardware processor to perform a method of using machine learning (ML) to identify anomalous vulnerability data among vulnerability data acquired for configuring vulnerability detection of a computer network security system configured to monitor a computing environment, the method comprising:
obtaining vulnerability data comprising a plurality of values of a vulnerability parameter, wherein the vulnerability parameter can be used to configure detection of at least one vulnerability in the computing environment by the computer network security system;
generating a plurality of datapoints representing the plurality of values of the vulnerability parameter;
clustering the plurality of datapoints to obtain a plurality of vulnerability parameter clusters;
identifying at least one outlier datapoint using the plurality of vulnerability parameter clusters, the at least one outlier datapoint indicating at least one anomalous value of the vulnerability parameter;
identifying anomalous vulnerability data among the obtained vulnerability data using the at least one outlier datapoint indicating the at least one anomalous value of the vulnerability parameter, and
outputting an indication of the anomalous vulnerability data.
